(19) United States
(12) Patent Application Publication
(10) Pub. No.: US 2026/0021400 A1
(43) Pub. Date: Jan. 22, 2026

(54) NON-TRANSITORY COMPUTER-READABLE STORAGE MEDIUM HAVING GAME PROGRAM STORED THEREIN, GAME SYSTEM, GAME PROCESSING METHOD, AND GAME APPARATUS

(71) Applicants: NINTENDO CO., LTD., Kyoto (JP); The Pokémon Company, Tokyo (JP)

(72) Inventor: Yuichi MURASE, Tokyo (JP)

(21) Appl. No.: 19/184,649

(22) Filed: Apr. 21, 2025

(30) Foreign Application Priority Data
Jul. 17, 2024 (JP) 2024-113974
Dec. 9, 2024 (JP) 2024-214604
Dec. 9, 2024 (JP) 2024-214605
Dec. 9, 2024 (JP) 2024-214606

(51) Int. Cl. A63F 13/56; A63F 13/52

(52) U.S. Cl. CPC A63F 13/56; A63F 13/52

(57) ABSTRACT

A player character is caused to perform a capturing motion of releasing a capture item, in response to a first instruction. When the capture item is released toward the first field character, a capture success determination as to whether or not a capture by the capturing motion is successful is performed. If the capture is successful, the first field character is brought into a state of being owned by a player. A first battle character among characters owned by the player is caused to perform an attack motion against a first field character, in response to a second instruction. If the first field character is defeated based on the attack motion, the first field character is made capturable in a first period after the defeat, and the first field character is made un-capturable after the first period has elapsed.

### CROSS REFERENCE TO RELATED APPLICATION

This application claims priority to Japanese Patent Application No. 2024-113974filed on Jul. 17, 2024, Japanese Patent Application No. 2024-214604 filed on Dec. 9, 2024, Japanese Patent Application No. 2024-214605 filed on Dec. 9, 2024, and Japanese Patent Application No. 2024-214606 filed on Dec. 9, 2024, the entire contents of which are incorporated herein by reference.

### FIELD

The present disclosure relates to game processing that performs processing on characters in a virtual space.

### BACKGROUND AND SUMMARY

Hitherto, a game in which, by a player character releasing a ball toward a character in a virtual space, it is possible to set a state where the player character captures and owns the character, has been known. In addition, a game in which, by releasing a battle character toward the character in the virtual space instead of the ball, it is possible to start a battle between the character and the battle character, has been known.

For the above game, there is no particular mention of whether or not it is possible to capture the character in the virtual space if the character is defeated in the above battle.

In view of the above, the following configuration examples are exemplified.

### Configuration 1

Configuration 1 is directed to a non-transitory computer-readable storage medium having stored therein a game program causing a computer of an information processing apparatus to: control a player character in a virtual space, based on an operation input; cause the player character to perform a capturing motion of releasing a capture item for capturing one or more field characters placed on a field, in a specified direction in response to a first instruction based on an operation input; in a scene where it is possible to capture a first field character among the field characters, when the capture item is released toward the first field character in accordance with the capturing motion, perform a capture success determination as to whether or not a capture by the capturing motion is successful, and if the capture is successful, bring the first field character into a state of being owned by a player; cause a first battle character among battle characters owned by the player and capable of battling on the field to perform an attack motion against the first field character in response to a second instruction based on an operation input; and perform a defeat determination as to whether or not the first field character has been defeated, based on the attack motion of the first battle character, and if the first field character has been defeated, make the first field character capturable in a first period after the defeat, and make the first field character un-capturable after the first period has elapsed.

According to the above configuration, even if the first field character is defeated, it is possible to obtain an opportunity to capture the first field character.

### Configuration 2

In Configuration 2 based on Configuration 1 above, the game program may further cause the computer to: when the first field character is in a battle state out of the battle state and a non-battle state, cause the first field character to perform an attack motion against the player character or the first battle character; and when the first field character is in the non-battle state, if the first battle character has performed an attack motion against the first field character, bring the first field character into the battle state.

According to the above configuration, the player can bring the first field character into the battle state from the non-battle state at any timing.

### Configuration 3

In Configuration 3 based on Configuration 2 above, the game program may further cause the computer to make the first field character capturable when the first field character is in the non-battle state.

According to the above configuration, it is possible to increase the opportunity for capture and improve the entertainment characteristics of the game

### Configuration 4

In Configuration 4 based on Configuration 3 above, the game program may further cause the computer to, when the first field character is in the non-battle state, bring the first field character into the battle state if a result of the capture success determination in accordance with the capturing motion against the first field character is a failure.

According to the above configuration, even if the capture in the non-battle state fails, an opportunity for capture is provided by defeating the first field character in the battle state later, so that it is possible to improve the entertainment characteristics of the game.

### Configuration 5

In Configuration 5 based on Configuration 2 above, the game program may further cause the computer to make the first field character capturable when the first field character is in the battle state.

According to the above configuration, it is possible to provide an opportunity to capture the first field character in a wider variety of situations, so that it is possible to improve the entertainment characteristics of the game.

### Configuration 6

In Configuration 6 based on Configuration 5 above, the game program may further cause the computer to: decrease hit points set for the first field character, based on an attack motion of the first battle character against the first field character; make it easier for a result of the capture success determination in accordance with the capturing motion to be a success as the hit points decrease; and if the hit points become equal to or lower than a predetermined value, perform the defeat determination that the first field character has been defeated.

According to the above configuration, a capture success rate can be increased by decreasing the hit points of the first field character, so that it is possible to improve the entertainment characteristics of the battle with the first field character. Furthermore, even if the first field character is defeated, an opportunity to capture the first field character is provided during the first period.

### Configuration 7

In Configuration 7 based on Configuration 6 above, the game program may further cause the computer to bring the first field character into a state of not performing the attack motion against the first battle character and not moving, during the first period.

According to the above configuration, it is possible to temporarily make it easy to release the capture item targeting the first field character.

### Configuration 8

In Configuration 8 based on Configuration 2 above, the game program may further cause the computer to, when the first battle character has not appeared on the field, in response to a third instruction based on an operation input, cause the player character to perform a battle character appearance motion of releasing the first battle character in a specified direction to cause the first battle character to appear on the field.

According to the above configuration, the position at which the first battle character is caused to appear can be specified to a certain extent.

### Configuration 9

In Configuration 9 based on Configuration 8 above, the game program may further cause the computer to bring the first field character into the battle state when the first battle character is released toward the first field character based on the battle character appearance motion.

### Configuration 10

In Configuration 10 based on Configuration 8 above, the game program may further cause the computer to: control the first battle character that has appeared on the field based on the battle character appearance motion, on the field; and bring the first field character into the battle state if a positional relationship between the first field character and the first battle character satisfies a predetermined condition.

### Configuration 11

In Configuration 11 based on any one of Configurations 1 to 10 above, the game program may further cause the computer to make it easier for a result of the capture success determination to be a success in the first period than in a period other than the first period in which the first field character is capturable.

According to the above configuration, the capture success rate is higher when the first field character is defeated, so that it is possible to provide motivation for battling with the first field character.

### Configuration 12

In Configuration 12 based on any one of Configurations 1 to 10 above, the game program may further cause the computer to, after the first period has elapsed, make the first field character un-capturable and delete the first field character from the field.

According to the above configuration, if the capture within the first period fails, the opportunity to capture the first field character is lost, so that it is possible to give the player a sense of tension for capturing the first field character within this period and improve the entertainment characteristics of the game.

### Configuration 13

In Configuration 13 based on any one of Configurations 1 to 10 above, the game program may further cause the computer to, if a result of the capture success determination is a success, bring the field character into a state of being owned as the battle character by the player.

According to the above configuration, while the player is provided with the enjoyment of collecting various field characters, an opportunity for capture in a variety of situations is also provided, so that it is possible to improve the entertainment characteristics of the game.

### Configuration 14

In Configuration 14 based on any one of Configurations 1 to 10 above, the game program may further cause the computer to: when the first battle character is caused to perform the attack motion, bring the first battle character into an attack standby state where the attack motion cannot be further performed; cancel the attack standby state to bring the first battle character into an attack-possible state, in accordance with passage of time; and cause the first battle character to perform the attack motion in response to a predetermined operation input being performed in the attack-possible state as the second instruction.

According to the above configuration, it is possible to provide the player with room to perform other actions during the attack standby state. Therefore, in performing an attack, it is possible to prevent a monotonous operation of repeating the same attack instruction from being performed, so that it is possible to improve the strategy of the attack and enhance the entertainment characteristics of the game.

### Configuration 15

In Configuration 15 based on any one of Configurations 1 to 10 above, the game program may further cause the computer to end the first period as a result of passage of time.

According to the above configuration, a time limit is set for the first period in which the capture success rate is increased, so that it is possible to give the player a sense of tension for capturing the first field character within this period and improve the entertainment characteristics of the game.

### Configuration 16

In Configuration 16 based on Configuration 15 above, the game program may further cause the computer to end the first period if the capturing motion is performed a predetermined number of times during the first period.

According to the above configuration, it is possible to give the player a greater sense of tension for capture within the first period and improve the entertainment characteristics of the game.

Each configuration example described above may be applied to a game system, a game processing method, or a game apparatus.

According to the exemplary embodiment, it is possible to provide a game in which a character on a field can be captured in a wider variety of situations.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 shows a non-limiting example of a game screen according to an exemplary embodiment;

FIG. 9 shows a non-limiting example of the game screen according to the exemplary embodiment;

FIG. 10 shows a non-limiting example of the game screen according to the exemplary embodiment;

FIG. 11 shows a non-limiting example of the game screen according to the exemplary embodiment;

FIG. 12 shows a non-limiting example of the game screen according to the exemplary embodiment;

FIG. 13 shows a non-limiting example of the game screen according to the exemplary embodiment;

FIG. 14 shows a non-limiting example of the game screen according to the exemplary embodiment;

FIG. 15 shows a non-limiting example of the game screen according to the exemplary embodiment;

FIG. 16 shows a non-limiting example of the game screen according to the exemplary embodiment;

FIG. 17 shows a non-limiting example of the game screen according to the exemplary embodiment;

FIG. 18 shows a non-limiting example of the game screen according to the exemplary embodiment;

FIG. 19 shows a non-limiting example of the game screen according to the exemplary embodiment;

FIG. 20 shows a non-limiting example of the game screen according to the exemplary embodiment;

FIG. 21 shows a non-limiting example of the game screen according to the exemplary embodiment;

FIG. 22 shows a non-limiting example of the game screen according to the exemplary embodiment;

FIG. 23 shows a non-limiting example of the game screen according to the exemplary embodiment;

FIG. 24 shows a non-limiting example of the game screen according to the exemplary embodiment;

FIG. 25 shows a non-limiting example of the game screen according to the exemplary embodiment;

FIG. 26 shows a non-limiting example of the game screen according to the exemplary embodiment;

FIG. 27 shows a non-limiting example of the game screen according to the exemplary embodiment;

FIG. 28 is a memory map showing a non-limiting example of various data stored in a DRAM 85;

FIG. 29 shows a non-limiting example of the data structure of character master data 309;

FIG. 30 shows a non-limiting example of the data structure of owned character data 310;

FIG. 31 shows a non-limiting example of the data structure of FC management data 318;

FIG. 32 is a non-limiting example of a flowchart showing the details of game processing according to the exemplary embodiment;

FIG. 33 is a non-limiting example of a flowchart showing the details of a PC control process;

FIG. 34 is a non-limiting example of a flowchart showing the details of a movement control process;

FIG. 35 is a non-limiting example of a flowchart showing the details of an appearance control process;

FIG. 36 is a non-limiting example of a flowchart showing the details of a readiness-related process;

FIG. 37 is a non-limiting example of a flowchart showing the details of a lock-on-related process;

FIG. 38 is a non-limiting example of a flowchart showing the details of a capturing action process

FIG. 39 is a non-limiting example of a flowchart showing the details of a capture determination process;

FIG. 40 is a non-limiting example of a flowchart showing the details of a BC control process;

FIG. 41 is a non-limiting example of a flowchart showing the details of the BC control process;

FIG. 42 is a non-limiting example of a flowchart showing the details of an FC control process;

FIG. 43 is a non-limiting example of a flowchart showing the details of a non-battle state process;

FIG. 44 is a non-limiting example of a flowchart showing the details of a battle state process;

FIG. 45 is a non-limiting example of a flowchart showing the details of the battle state process; and

FIG. 46 is a non-limiting example of a flowchart showing the details of a chance state process.

### DETAILED DESCRIPTION OF NON-LIMITING EXAMPLE EMBODIMENTS

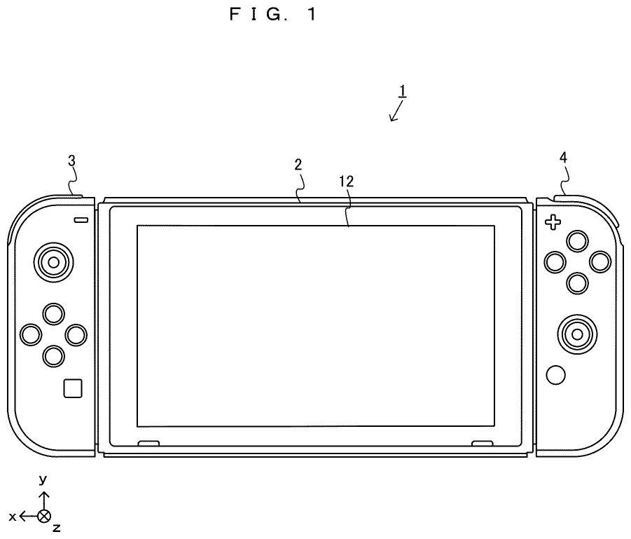

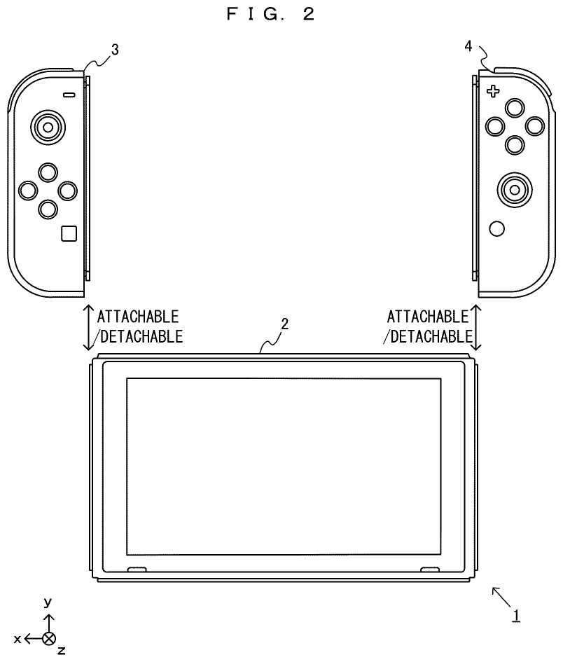

Hereinafter, an exemplary embodiment will be described. FIG. 1 shows an example of the appearance of a game system according to the exemplary embodiment. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a player provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

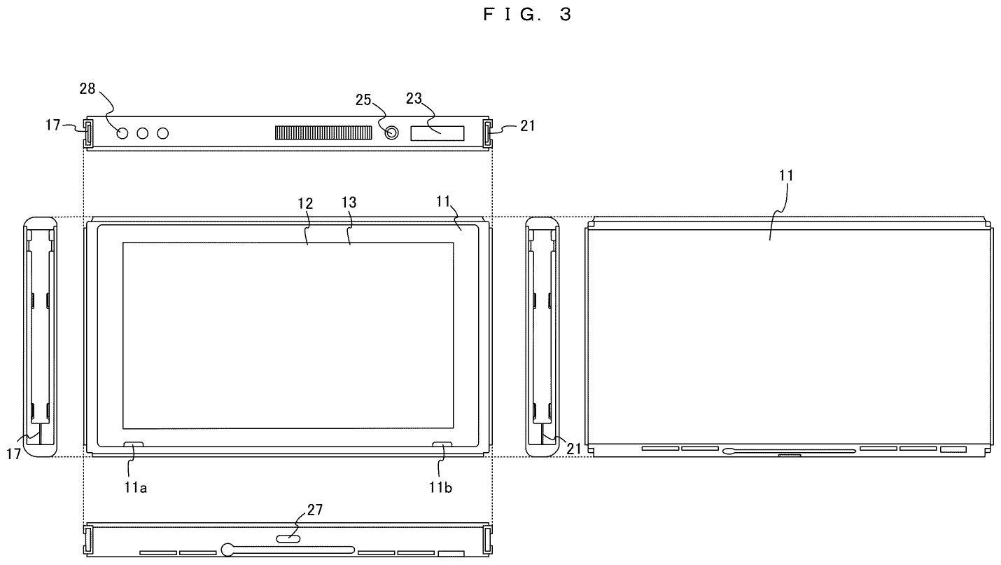

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

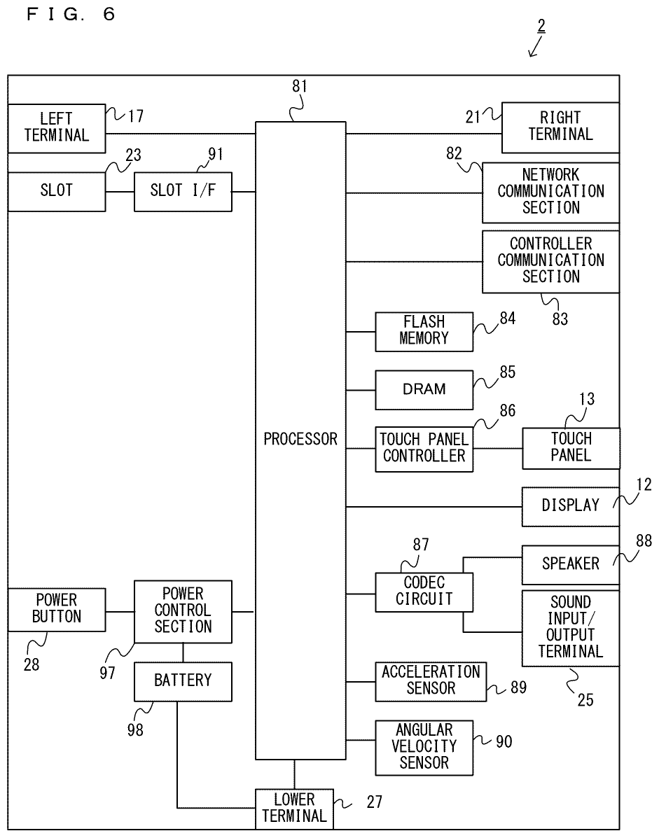

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

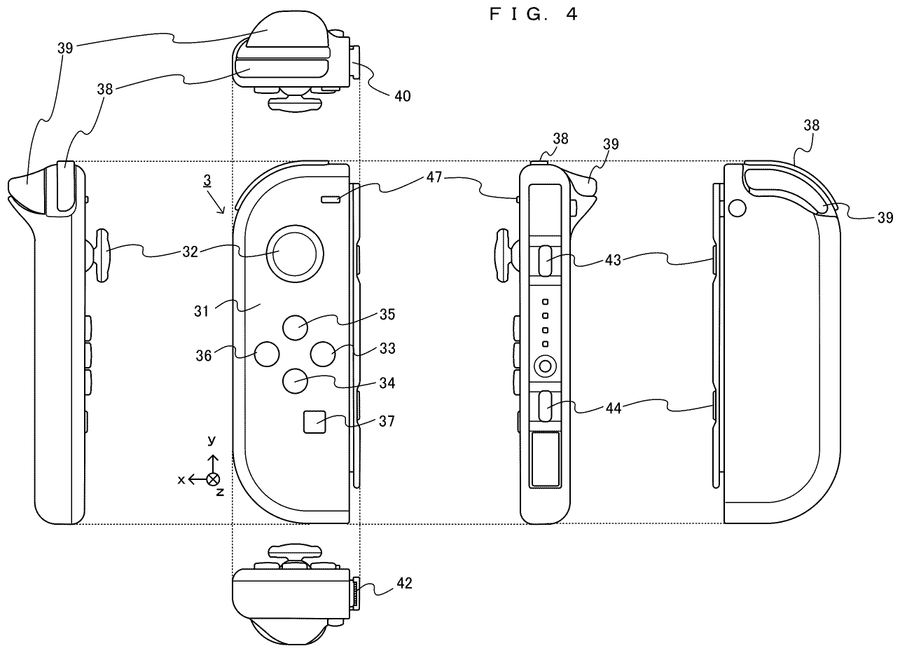

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a y-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

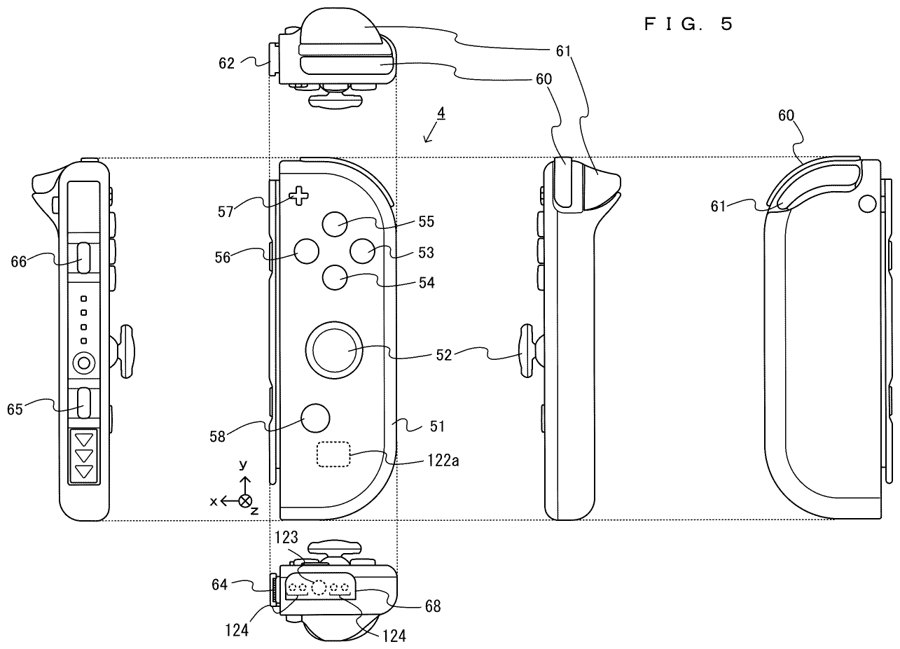

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the y-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

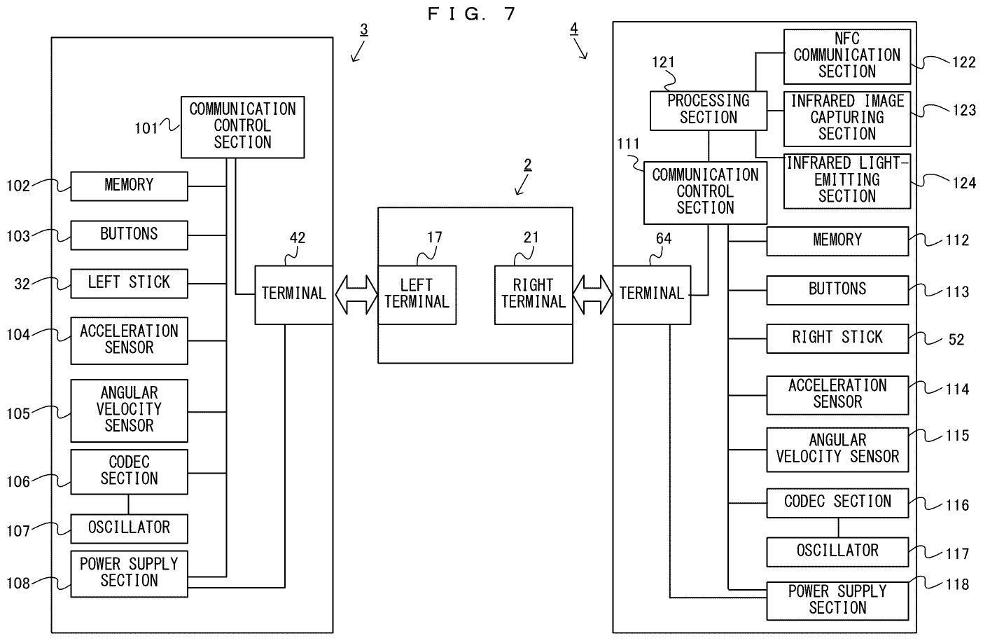

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a vibrator 107 for notifying a user by vibration. In the exemplary embodiment, the vibrator 107 is controlled by a command from the main body apparatus 2. That is, when the communication control section 101 receives the above command from the main body apparatus 2, the communication control section 101 drives the vibrator 107 according to this command. Here, the left controller 3 includes a codec section 106. When the communication control section 101 receives the above command, the communication control section 101 outputs a control signal corresponding to the command, to the codec section 106. The codec section 106 generates a drive signal for driving the vibrator 107 from the control signal from the communication control section 101 and provides the drive signal to the vibrator 107. Accordingly, the vibrator 107 operates.

The vibrator 107 is more specifically a linear vibration motor. Unlike a normal motor that performs rotational motion, the linear vibration motor is driven in a predetermined direction according to an inputted voltage and thus can be vibrated at an amplitude and a frequency corresponding to the waveform of the inputted voltage. In the exemplary embodiment, the vibration control signal transmitted from the main body apparatus 2 to the left controller 3 may be a digital signal representing the frequency and the amplitude per unit time. In another exemplary embodiment, information indicating the waveform itself may be transmitted from the main body apparatus 2, but by transmitting only the amplitude and the frequency, the amount of communication data can be reduced. In addition, in order to further reduce the amount of data, only the differences from the previous values may be transmitted instead of the values of the amplitude and the frequency at that time. In this case, the codec section 106 converts the digital signal indicating the amplitude and frequency values acquired from the communication control section 101 into an analog voltage waveform and drives the vibrator 107 by inputting a voltage in accordance with this waveform. Therefore, the main body apparatus 2 can control the amplitude and the frequency for vibrating the vibrator 107 at that time, by changing the amplitude and the frequency transmitted per unit time. Each of the amplitude and the frequency transmitted from the main body apparatus 2 to the left controller 3 is not limited to one, and two or more amplitudes and two or more frequencies may be transmitted. In that case, the codec section 106 can generate a waveform of the voltage for controlling the vibrator 107 by synthesizing the waveforms that are indicated by the received multiple amplitudes and frequencies, respectively.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 also includes a vibrator 117 and a codec section 116. The vibrator 117 and the codec section 116 operate in the same manner as the vibrator 107 and the codec section 106 of the left controller 3. That is, the communication control section 111 operates the vibrator 117, using the codec section 116, according to a command from the main body apparatus 2.

The right controller 4 includes a power supply section 118. The power supply section 118 has a function similar to that of the power supply section 108 of the left controller 3 and operates similarly to the power supply section 108.

### Outline of Game Processing in Exemplary Embodiment

Next, the outline of operation of the game processing executed by the game system 1 according to the exemplary embodiment will be described. As described above, in the game system 1, the main body apparatus 2 is configured such that each of the left controller 3 and the right controller 4 is attachable thereto and detachable therefrom. In the case of playing the game with the left controller 3 and the right controller 4 attached to the main body apparatus 2, a game image is outputted to the display 12. In the case where the main body apparatus 2 alone with the left controller 3 and the right controller 4 detached therefrom is mounted on the cradle, the main body apparatus 2 can output a game image to a stationary monitor or the like via the cradle. In the exemplary embodiment, the case of playing the game in the latter manner will be described as an example. Specifically, the main body apparatus 2 alone with the left controller 3 and the right controller 4 detached therefrom is mounted on the cradle, and the main body apparatus 2 outputs a game image and the like to a stationary monitor or the like via the cradle.

In the following description, the left controller 3 and the right controller 4 are collectively referred to simply as “controller”.

### Assumed Game

Next, a game assumed in the exemplary embodiment will be described. The game according to the exemplary embodiment is a game in which a player character (hereinafter referred to as “PC”) captures and owns a field character (hereinafter referred to as “FC”) that is on a virtual field (hereinafter referred to simply as “field”) in a virtual space. More specifically, in the exemplary embodiment, when the PC throws a capture item toward the FC, a determination as to whether or not capture is successful is performed, and if the capture is successful, it is possible to capture this FC. In the exemplary embodiment, processing related to the above capture will be mainly described.

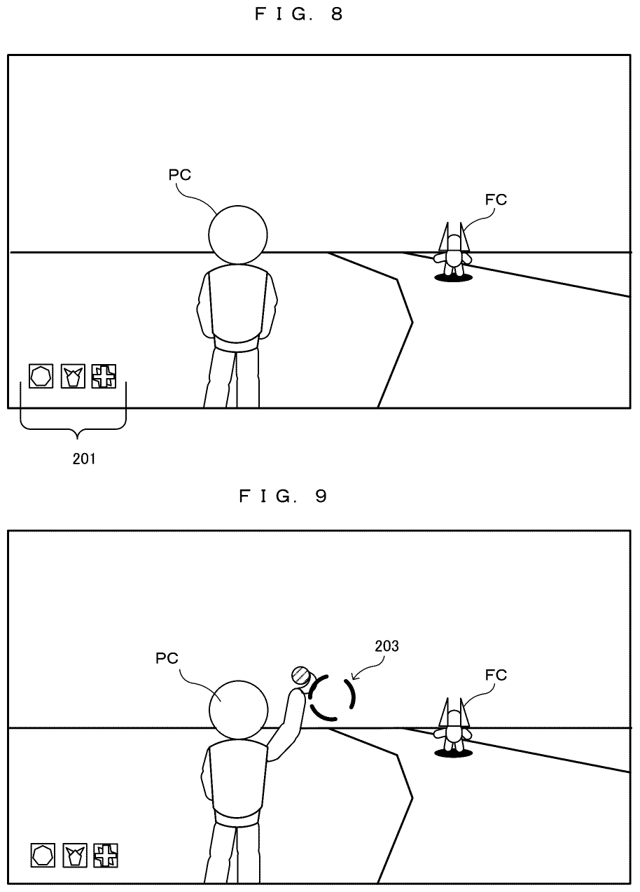

Hereinafter, the outline of the processing related to the above capture in the exemplary embodiment will be described using screen examples. FIG. 8 shows an example of a game image of this game. In FIG. 8, a three-dimensional virtual space is displayed in a third person view seen from a viewpoint behind the PC. In FIG. 8, the PC, the FC, and an owned character section 201 are displayed. The FC in FIG. 8 is in a “non-battle state” described later. As will be described in more detail later, the FC can shift from the “non-battle state” to a “battle state” or a “chance state”. In addition, characters (hereinafter referred to as owned characters) owned by the PC at that time are displayed in the owned character section 201. The example in FIG. 8 shows that the PC owns three owned characters.

Here, movement operations and camera operations in this game will be described. In this game, the player can move the PC in the desired direction on the field in the virtual space by operating the left stick 32. In addition, the player can change the orientation of a virtual camera by operating the right stick 52.

Next, an operation example related to the above capture will be described using a screen example. In this game, by throwing the above capture item toward the FC, an attempt to capture the FC can be made. To give a specific operation example, when the player presses the ZR-button 61 (hereinafter referred to as ready operation) in the state in FIG. 8, the PC shifts to a state of “being ready” in order to throw a capture item 202, as shown in FIG. 9. FIG. 9 shows a state where the PC is holding the ball-shaped capture item 202 in its right hand and is raising its right arm. Hereinafter, this state is referred to as “ready state”. The “ready state” basically continues while the ZR-button 61 is continuously pressed. The state of the PC that is not in the “ready state” (the state in FIG. 8 above) is referred to as as “normal state”.

In addition, when the PC shifts to the ready state, a sight 203 is also displayed at the screen center as shown in FIG. 9 above. The sight 203 indicates a direction in which (or a landing point to which) the capture item 202 is thrown. In the ready state, if the player stops pressing the ZR-button 61 (separates their finger from the ZR-button 61), the PC performs a motion of throwing the capture item toward the sight 203 (hereinafter referred to as capturing action).

Also, if the PC is moved in the state in FIG. 9 above, the PC makes a “strafing movement” in which the PC moves left and right without changing the orientation of the PC. In this case, the sight 203 moves left and right in a state of being always displayed at the screen center. FIG. 10 shows an example of moving the PC slightly to the right from the state in FIG. 9 above. Since the capture item 202 is thrown toward the sight 203, it is also possible to throw the capture item 202 toward a target other than the FC, for example.

### Lock-On

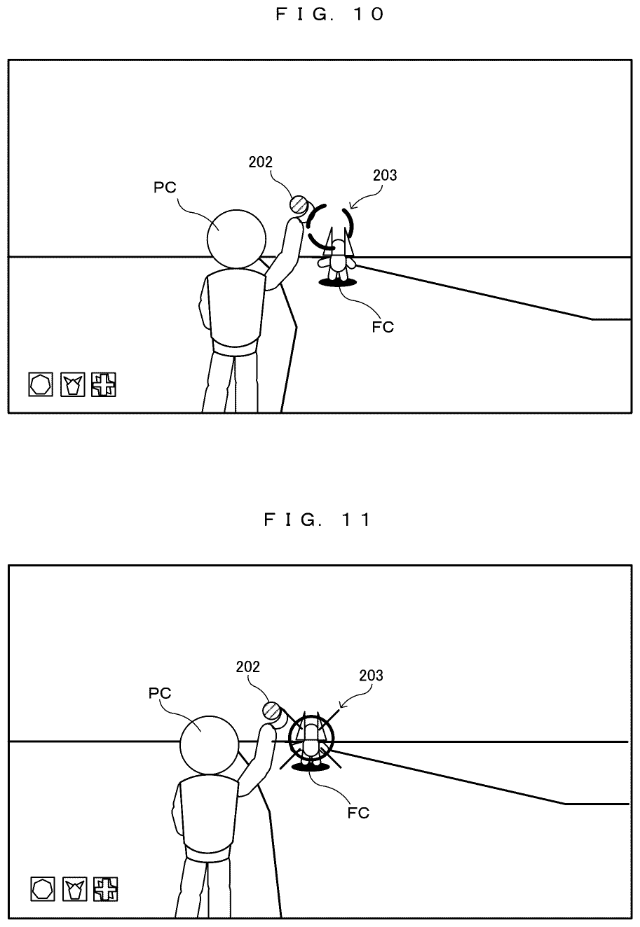

Here, supplementary description will be given regarding a lock-on function of the sight 203. In this game, for example, by pressing the ZL-button 39 (hereinafter referred to as lock-on operation) in the ready state shown in FIG. 10 above, the sight 203 can be fixed to the nearest FC to lock on this FC as shown in FIG. 11. When lock-on is performed, the display form of the sight 203 also changes slightly such that it is possible to recognize that the lock-on has been performed. Also, during lock-on, the target that has been locked on is displayed such that the target is positioned at the screen center (that is, the sight 203 is maintained at the screen center). Then, if the capture item 202 is thrown in a locked-on state, the capture item 202 is thrown toward the locked-on FC. Also, by separating the finger from the ZL-button 39 (hereinafter referred to as lock-off operation), the lock-on is cancelled. In addition, during lock-on, if there is another FC within a predetermined range, the locked-on target can be switched to the other FC by operating the right stick 52. In other words, during lock-on, the orientation of the virtual camera cannot be changed using the right stick 52.

Also, if the PC is moved during lock-on, since the sight 203 is fixed to the FC, movement control is performed such that the sight 203 and the locked-on FC are always displayed at the screen center. That is, movement control (and virtual camera control) is performed while the PC (the virtual camera) is caused to always face the locked-on FC.

### Capturing Action

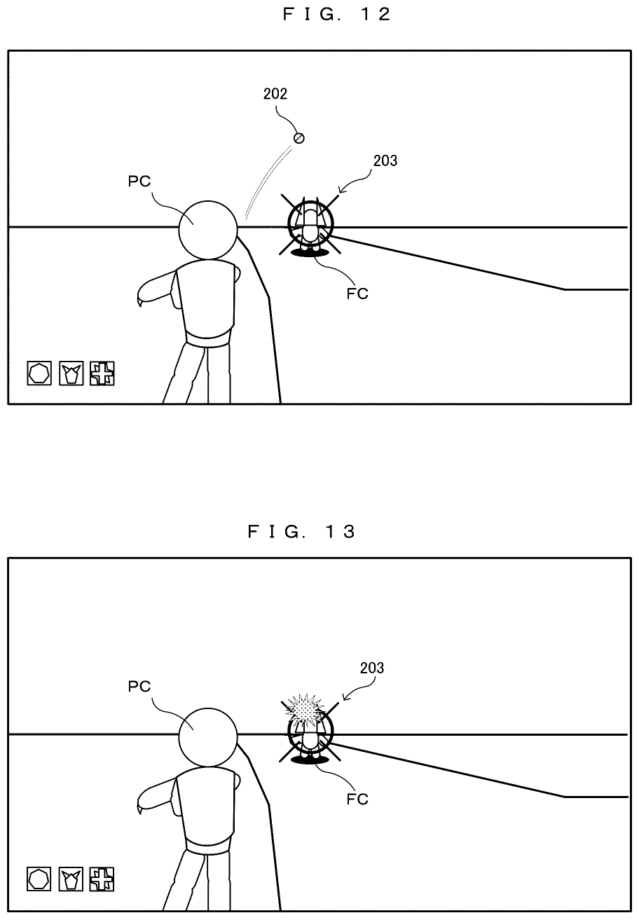

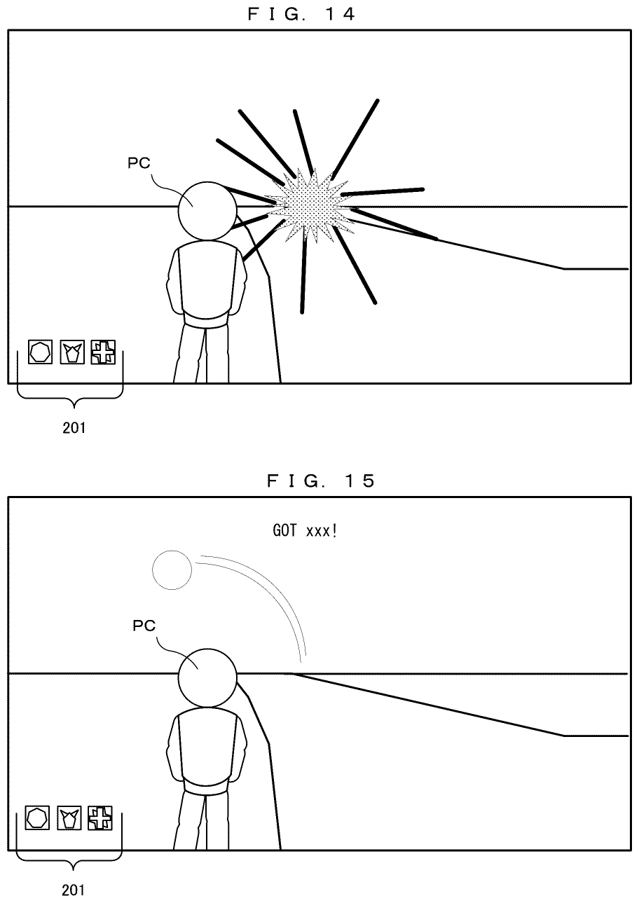

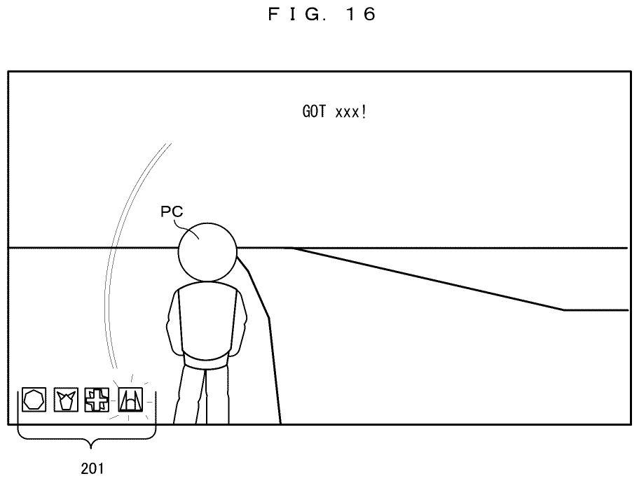

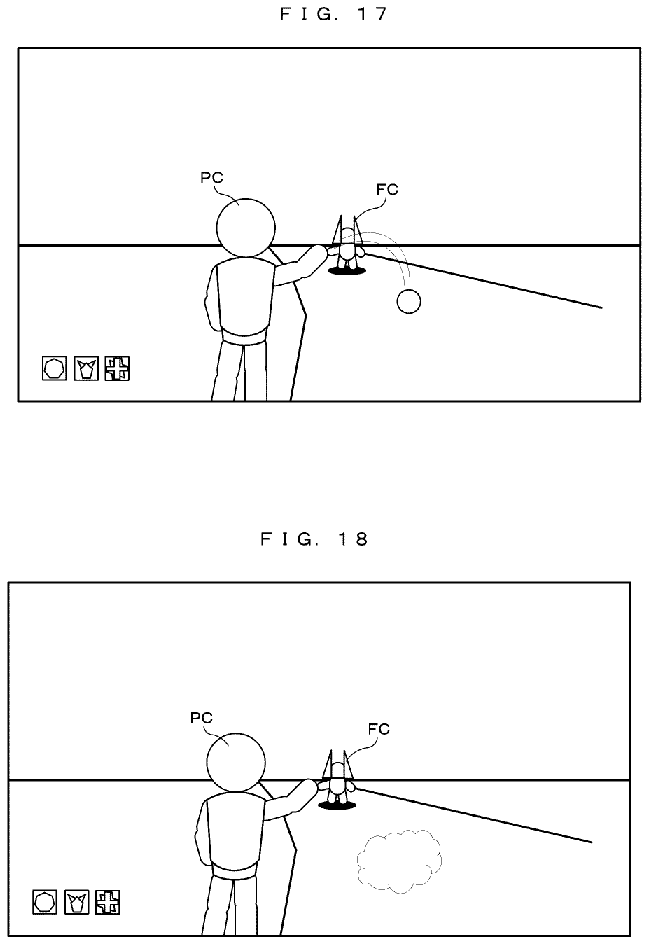

Next, the above capturing action will be described in more detail. As described above, when the player stops pressing the ZR-button 61 in the ready state, the capture item 202 can be thrown toward the sight 203 as shown in FIG. 12. In the following, a state from when the PC starts a motion of throwing the capture item until a result of the capture determination is obtained is referred to as capturing action state. That is, when the player stops pressing the ZR-button 61, the PC shifts from the ready state to the capturing action state. After the result of capture determination is obtained, the PC shifts to the normal state. FIG. 12 shows an example in which the capture item 202 is thrown in a locked-on state. Therefore, the capture item 202 moves toward the locked-on FC. As a result, as shown in FIG. 13, the capture item 202 is assumed to have hit the FC. When the capture item 202 hits the FC, a determination as to whether or not capture is successful (hereinafter referred to as capture determination) is performed. In this example, a capture success rate is set in advance for each FC, and whether or not capture is successful is determined by making a random selection using the capture success rate. As will be described in detail later, this capture success rate can be adjusted according to the situation. If, as a result of the capture determination, the capture is successful, a representation in which the FC disappears from the field (hereinafter referred to as disappearance representation) is displayed as shown in FIG. 14, and a capture representation is then displayed as shown in FIG. 15 and FIG. 16. In the capture representation shown in FIG. 15, a representation in which a ball-shaped object (indicating that the FC is inside the thrown capture item 202) is flying toward the owned character section 201, is displayed. Then, as shown in FIG. 16, a display in which the FC captured this time has been added to the owned character section 201, is performed. The example in FIG. 16 shows that the FC captured this time has been added as the fourth owned character.

On the other hand, if, as a result of the capture determination, the capture fails, the state of the FC shifts from the “non-battle state” to the “battle state”. The FC in the “battle state” attacks the PC or a battle character (hereinafter referred to as BC) described below.

In the exemplary embodiment, the number of owned capture items 202 is limited. If the above capturing action is performed once, one capture item 202 is consumed regardless of whether or not the capture is successful. In addition, in the exemplary embodiment, there is only one type of capture item 202, but in another exemplary embodiment, there may be multiple types of capture items 202 with different performance characteristics. For example, in addition to the normal capture items 202, there may be a high-performance capture item 202 that increases a capture success rate by 10%. When shifting to the above ready state, it may be possible to specify the type of capture item 202 to be used.

In addition to stopping pressing the ZR-button 61, the ready state can also be cancelled by pressing the B-button 54 while pressing the ZR-button 61 (hereinafter referred to as readiness cancellation operation).

### Battle

Next, the above capture and elements of a battle with the FC will be described. In this game, the PC cannot directly attack the FC. In order to battle with the FC, it is necessary to use the above BC. Specifically, it is necessary to cause the BC to appear on the field by performing a predetermined operation, and then cause the BC to battle with the FC. Here, in this game, in the case of battling with the FC, the screen does not switch to a separate battle screen, such as a battle scene, and a battle with the FC is seamlessly started when a battle start condition is satisfied. In addition, the BC performs an attack action based on an instruction from the player, and the FC performs an attack action based on a predetermined algorithm, so that the battle is carried out in real time. The battle start condition includes the case where the capturing action fails in the above “non-battle state”, the case where the FC notices that the PC or BC has approached, or the case where the FC is attacked by the BC without noticing that the BC has approached, as described below.

Prior to the description of the elements of a battle, first, the BC will be described. In this game, among the owned characters of the PC, one owned character that is in a state where the owned character can battle can be selected and caused to appear on the field as the above BC. Hereinafter, the operation for causing the BC to appear on the field is referred to as “BC appearance operation”.

FIG. 17 to FIG. 19 each show a screen example (appearance representation example) when the BC appearance operation is performed. This screen example is an example in the case where, in a state where the PC is present at a position shown in FIG. 10 above, the player selects an owned character desired to appear by performing a predetermined operation and performs the BC appearance operation for causing the BC to appear. In this case, the selected owned character appears as the BC at a predetermined position, for example, diagonally in front of the PC. In the appearance representation shown in FIG. 17 to FIG. 19, first, a ball containing the owned character to be caused to appear as the BC (hereinafter referred to as BC ball) is thrown in a predetermined direction as shown in FIG. 17. Then, a representation such as smoke is displayed at the landing point of the BC ball as shown in FIG. 18. Then, the selected owned character appears as the BC as shown in FIG. 19. The player may be allowed to specify the position at which the BC is caused to appear or the direction in which the BC ball is thrown. For example, a cursor that is movable within a predetermined range centered at the PC and is for specifying an appearance position may be displayed, and the player may be allowed to operate the cursor. Then, the PC may throw the BC ball in the direction toward the cursor or toward the position where the cursor is located.

In addition, when the BC appears, a BC information section 204 and an attack choice section 205 are additionally displayed on the screen as shown in FIG. 19. The BC information section 204 shows a face image of the BC that has appeared and a hit point bar indicating the hit points of the BC. The attack choice section 205 is composed of a set of four diamond-shaped images and shows attack methods that can be used by the BC. The player can give an attack instruction to the BC by referring to the attack choice section 205. Specifically, in this game, each BC (FC) has a maximum of four types of attack methods. These four types of attack methods are each displayed so as to be assigned to one of the A-button 53, the B-button 54, the X-button 55, and the Y-button 56 (hereinafter collectively referred to as ABXY buttons) of the controller, and constitute the attack choice section 205. The respective four diamond-shaped images are arranged to imitate the layout of the ABXY buttons, so that it is easy to intuitively grasp which attack method corresponds to which button. Therefore, by pressing any of the ABXY buttons, the player can cause the BC to perform an attack action using the attack method corresponding to the pressed button.

The BC that has appeared as described above can act autonomously to a certain extent based on a predetermined algorithm. For example, if there is no FC in the vicinity of the BC, the BC moves to follow the PC. In addition, if there is an FC in the vicinity of the BC, the BC approaches the FC. Moreover, the player can also instruct the BC to act.

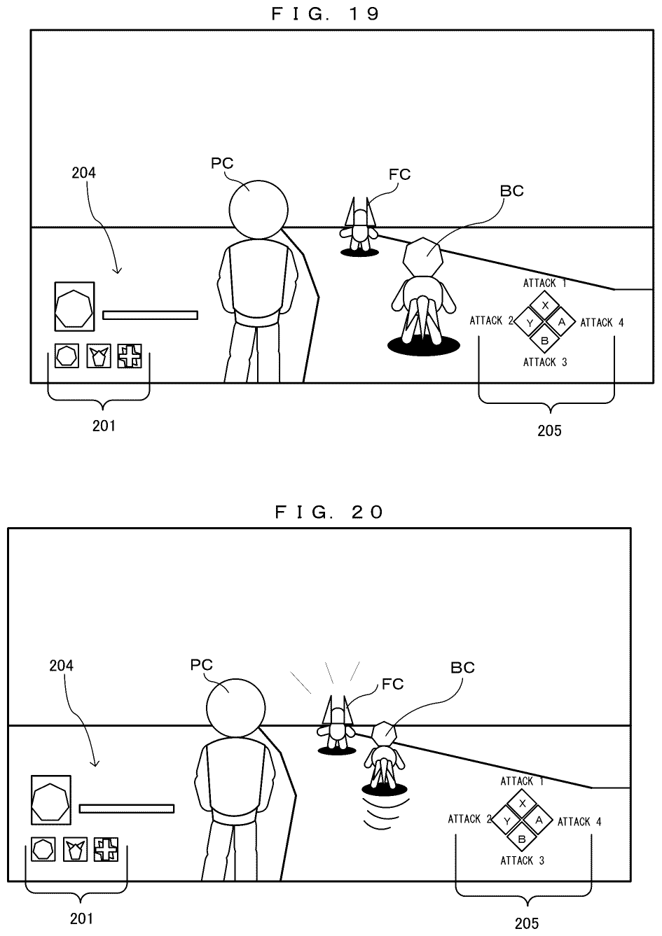

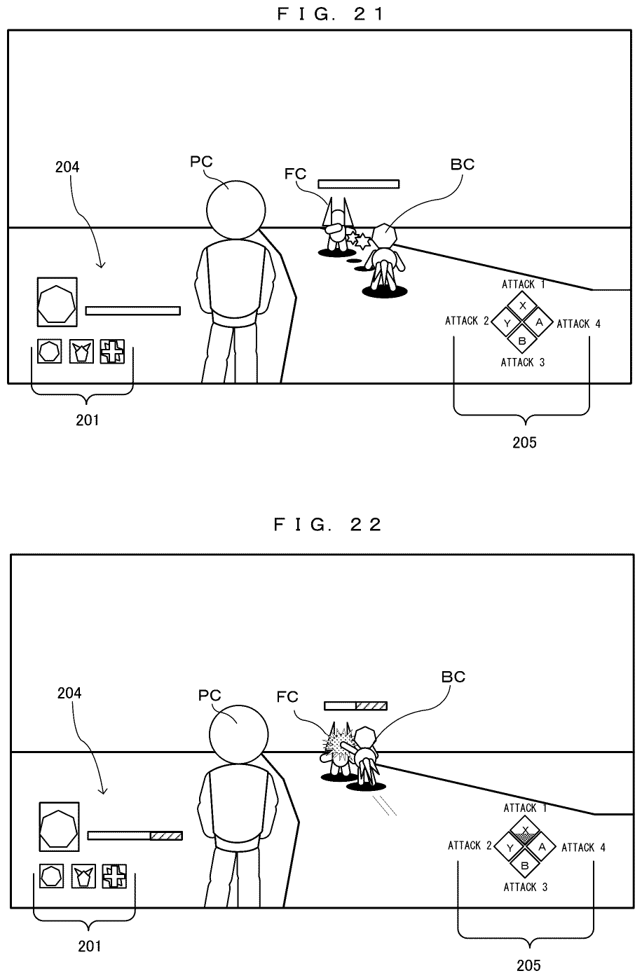

FIG. 20 shows a situation in which the BC has approached the FC to a certain extent in response to an instruction from the player or as a result of the autonomous action of the BC. In other words, FIG. 20 shows a situation in which the positional relationship between the FC and the BC satisfies a predetermined condition, in this case, a condition that the distance therebetween is equal to or less than a certain distance. In this case, the FC is treated as having “noticed” the presence of the BC. As a result, the FC shifts from the “non-battle state” to the “battle state” and attacks the BC as shown in FIG. 21. At the position of the head of the FC that has shifted to the “battle state”, a hit point bar indicating the hit points of this FC is displayed. In addition, not only when the BC approaches the FC, but also when the PC approaches the FC, the FC may become aware of the PC and shift to the “battle state”.

Next, FIG. 22 shows a screen example when the player presses the X-button 55 to give an attack instruction to the BC. FIG. 22 shows a situation in which, based on the attack instruction from the player, the BC performs an attack action against the FC using an attack method “Attack 1” assigned to the X-button 55. In addition, FIG. 22 also shows that, as a result of the attack hitting the FC, damage corresponding to this attack method is added to the FC, and the hit points of the FC are decreased.

### Charge Time

Here, in this game, a “charge time” is set for each attack method. When an attack method is used once, it is impossible to use this attack method until the charge time has elapsed. When the charge time has elapsed, it becomes possible to use the attack method. That is, for an attack method, during charge, it is in an attack standby state, and when charge is not performed, it is in an attack-possible state. For example, when the player gives an instruction of an attack using the attack method corresponding to the A-button 53, if this method is being charged, it is necessary to press the A-button 53 after waiting for the charge time and shifting to an attack-possible state. Therefore, in this game, the same attack method cannot be continuously used. The same applies to control of an attack action of the FC. During charging, for example, as shown in FIG. 22, a representation in which a charge meter rises from the bottom to the top is displayed for the diamond-shaped image corresponding to the used attack method.

### Chance State

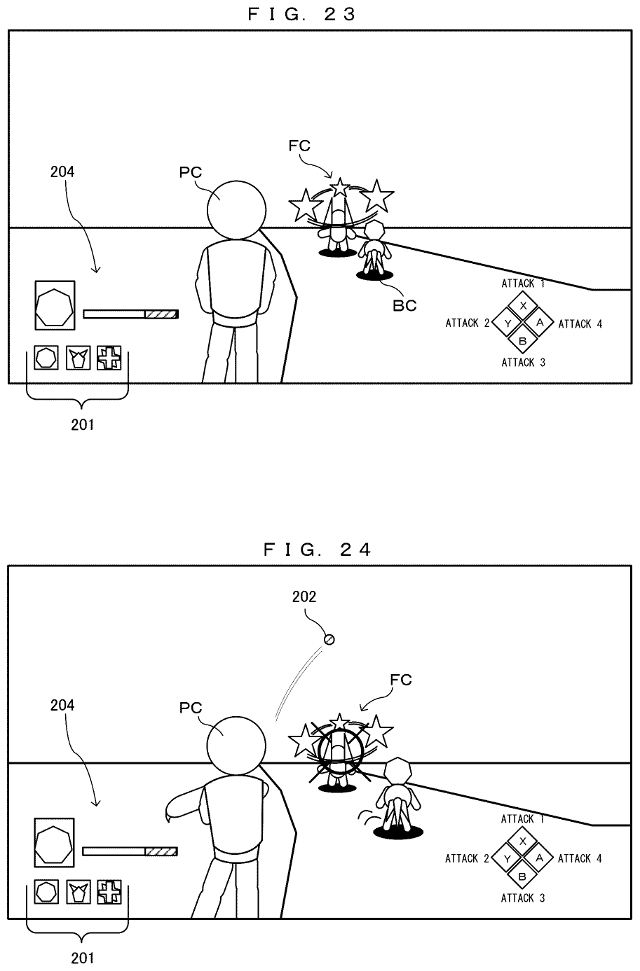

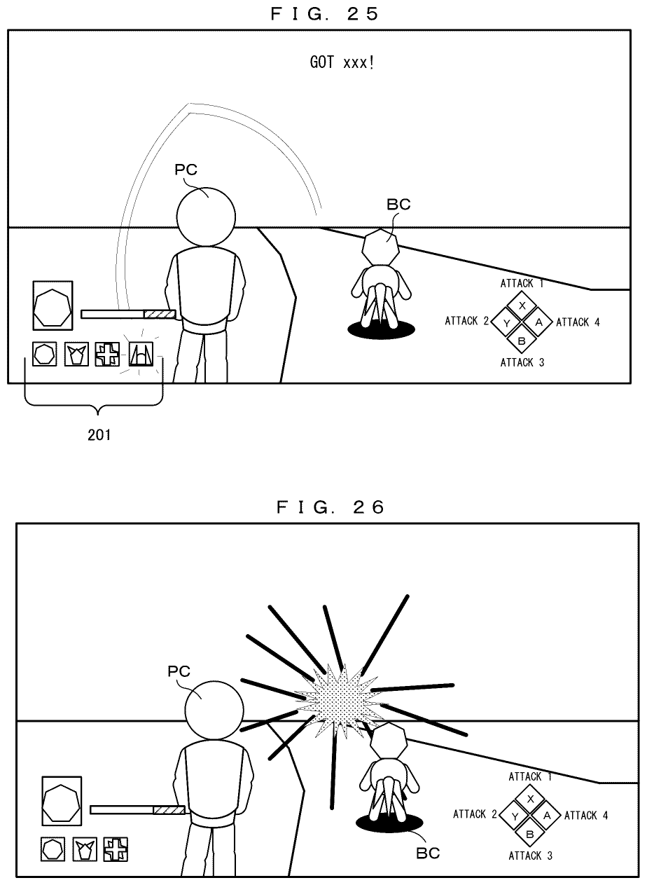

If, as a result of causing the FC to attack the BC as described above, the hit points of the FC finally reach 0, the FC is considered to have been defeated, and the FC shifts from the “battle state” to the “chance state”. The “chance state” continues only for a fixed period of time. In the “chance state”, the FC is in a state of being unable to act (state of neither moving nor performing an attack motion). In addition, the “chance state” is a state where the capture success rate is higher than when the FC is not in the chance state (e.g., a default success rate). When the FC has shifted to the “chance state”, a “capture chance representation” in which a star mark circles the FC is displayed as shown in FIG. 23. This indicates a state where the FC is not moving or attacking and has a dim consciousness. In this “chance state”, by causing the PC to perform a capturing action as shown in FIG. 24, the capture determination can be attempted with a higher success rate than when the FC is the above “non-battle state”. In addition, the capture determination can be attempted with a higher success rate than when the FC is in the “battle state”. As a result, if the capture is successful, the above-described capture representation is displayed, and the FC can be added as an owned character as shown in FIG. 25.

During the “chance state”, the player can cause the PC to perform capturing actions as many times as desired. Therefore, even if the first capturing action fails in the “chance state”, it is possible to cause the PC to perform a second capturing action and try to capture the target again.

On the other hand, if the fixed period of time elapses without the capture being successful or without a capturing action being performed, the “chance state” ends. In this case, as shown in FIG. 26, the above disappearance representation is displayed, the FC disappears from the field, and a state where the FC does not exist on the field is entered.

It is also possible to give an attack instruction to the BC to attack the FC or attempt to perform a capturing action without the FC noticing. For example, it is also possible to approach the FC from behind the FC and launch a preemptive attack from behind the FC without the FC noticing. In this case as well, the above battle start condition is satisfied, and the FC shifts from the “non-battle state” to the “battle state” (if there are hit points left). In that case, if the hit points of the FC reach 0 as result of the preemptive attack, the FC shifts from the “non-battle state” directly to the “chance state”. On the other hand, if the BC approaches the FC from behind the FC and performs a capturing action from behind the FC without the FC noticing, the success rate of the capture determination may be made higher than when the FC notices.

In addition, when throwing the BC ball to cause the BC to appear, it may also be possible to specify the position of the FC in the “non-battle state” as the landing point of the BC ball. That is, the PC throws the BC ball toward the FC. In this case, if the BC ball hits the FC, the FC is considered to have been attacked by the BC and is caused to shift to the “battle state”. In addition, even if the BC ball does not hit the FC, as a result of the BC appearing near the FC, the FC is considered to have noticed the presence of the BC and shifts to the “battle state”.

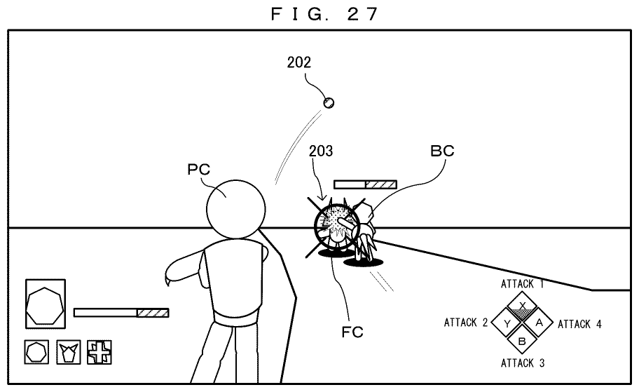

In this game, as shown in FIG. 27, the above capturing action can also be performed against the FC in the “battle state”. In this case, the capture success rate is adjusted in accordance with the remaining number of hit points of the FC at that time. Specifically, the success rate is adjusted such that the fewer the hit points are, the higher the success rate is.

As described above, in the exemplary embodiment, it is possible to directly attempt to capture an FC in the non-battle state. In addition, by attacking and defeating an FC to bring the FC into the chance state, it is also possible to attempt to capture the FC in a state where the capture success rate is made higher. Furthermore, it is also possible to attempt to capture an FC even during battle. As described above, the game according to the exemplary embodiment is a game in which an opportunity for capture is provided in a variety of situations.

### Details of Game Processing of Exemplary Embodiment

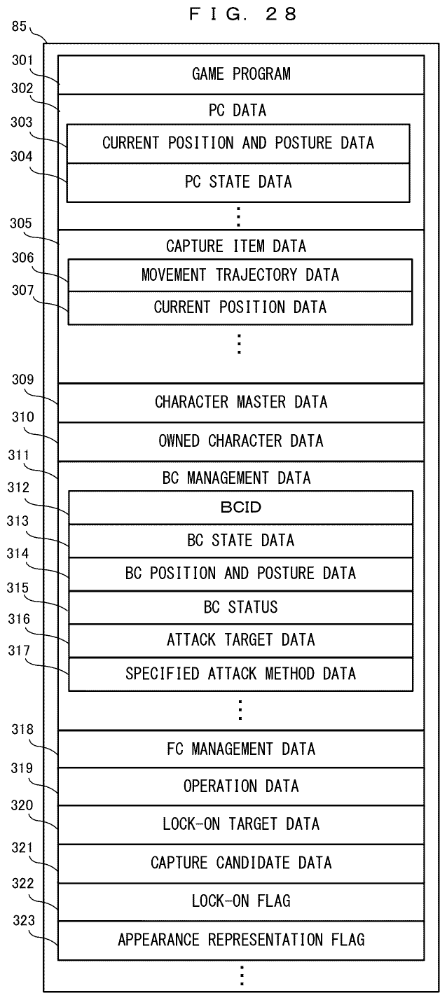

Next, the game processing in the exemplary embodiment will be described in more detail with reference to FIG. 28 to FIG. 46. Here, the processing related to the capture will be mainly described, and the detailed description of other game processing is omitted.

### Data to be Used

First, various data to be used in the game processing will be described. FIG. 28 illustrates a memory map showing an example of various data stored in the DRAM 85 of the main body apparatus 2. In the DRAM 85 of the main body apparatus 2, a game program 301, PC data 302, capture item data 305, character master data 309, owned character data 310, BC management data 311, FC management data 318, operation data 319, lock-on target data 320, capture candidate data 321, a lock-on flag 322, an appearance representation flag 323, etc., are stored.

The game program 301 is a program for executing the game processing in the exemplary embodiment.

The PC data 302 is data regarding the above PC. The PC data 302 includes current position and posture data 303, PC state data 304, etc. In addition, although not shown, the PC data 302 also includes various data required for the game processing, such as data indicating the external appearance of the PC (polygon data, etc.) and data of various motions performed by the PC (animation data).

The current position and posture data 303 is data indicating the current position and the current posture of the PC on the field. In addition, the PC state data 304 is data indicating the current state of the PC. Specifically, the PC state data 304 is set with information indicating one of the “normal state”, the “ready state”, and the “capturing action state” described above.

The capture item data 305 is data regarding the above capture item 202. The capture item data 305 includes movement trajectory data 306, current position data 307, etc. The movement trajectory data 306 is data indicating a movement path of the capture item 202 calculated based on the position of the above sight 203. The current position data 307 is data indicating the current position of the capture item 202. In addition, the capture item data 305 also includes, for example, data indicating the external appearance of the capture item 202, etc.

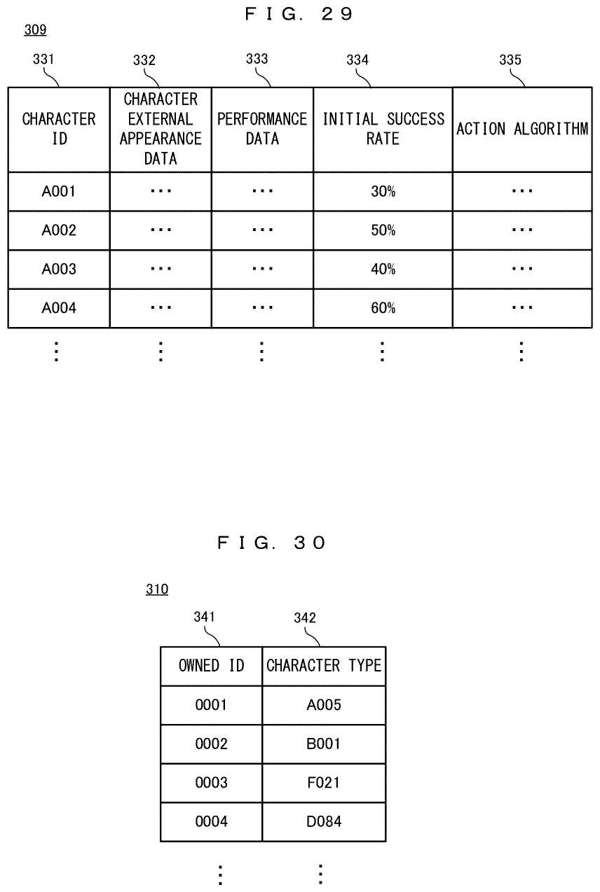

The character master data 309 is master data that defines the characters (FC, BC) that appear in this game other than the PC. FIG. 29 shows an example of the structure of the character master data 309. The character master data 309 is a database consisting of a set of records each including at least items such as a character ID 331, character external appearance data 332, performance data 333, an initial success rate 334, and an action algorithm 335. The character ID 331 is an ID for identifying each character. The character external appearance data 332 is data indicating the external appearance of the character. The performance data 333 is data that defines the performance and the initial status of the character. The performance data 333 is, for example, data that defines hit points and owned attack methods. The initial success rate 334 is data indicating the default capture success rate of the character. The action algorithm 335 is data that defines an action algorithm for the character. The action algorithm is defined separately for the case where the character is an FC and the case where the character is a BC. In addition, although not shown, various data required for the game processing are also included.

Referring back to FIG. 28, the owned character data 310 is data indicating characters owned by the PC (i.e., characters captured by the PC). FIG. 30 shows an example of the data structure of the owned character data 310. The owned character data 310 is a database consisting of a set of records each including at least items such as an owned ID 341 for uniquely identifying an owned character and a character type 342. As the character type 342, any of the above character IDs 331 is set. Here, in the exemplary embodiment, a plurality of characters of the same type (characters having the same ID as the character ID 331) can appear as separate FCs, respectively. It is also possible to own the same type of characters as owned characters. In this case, for the same type of characters, different owned IDs 341 are assigned, and these characters are managed as separate owned characters, respectively.

Referring back to FIG. 28, the BC management data 311 is data for managing the above BC. The BC management data 311 includes a BC ID 312, BC state data 313, BC position and posture data 314, a BC status 315, attack target data 316, specified attack method data 317, etc. The initial value of the BC management data 311 is empty data, which indicates that there is no BC (no BC has appeared).

As the BC ID 312, the above owned ID 341 corresponding to the owned character caused to currently appear as the BC is set. The BC state data 313 is data indicating the current state of the BC. Examples of the state of the BC include the “non-battle state” and the “battle state” described above, etc. The BC position and posture data 314 is data indicating the current position and the current posture of the BC. The BC status 315 is data indicating the current hit points, etc., of the BC. The attack target data 316 is data specifying an FC to be attacked by the BC. The specified attack method data 317 is data indicating the current attack method specified by an instruction from the player. This data is used for calculation of damage to be given to the FC, etc.

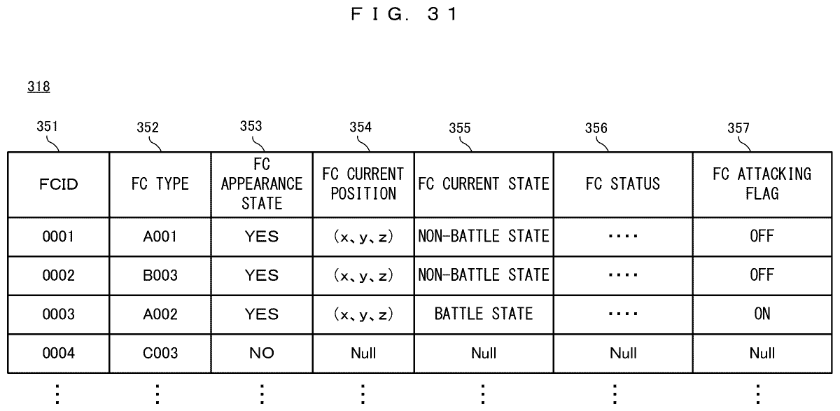

The FC management data 318 is data for managing FCs. FIG. 31 shows an example of the data structure of the FC management data 318. The FC management data 318 is a database consisting of a set of records each including at least items such as an FC ID 351, an FC type 352, an FC appearance state 353, an FC current position 354, an FC current state 355, a FC status 356, and an FC attacking flag 357. The FC ID 351 is an ID for uniquely identifying each FC existing on the field. The FC type 352 is an ID for specifying the character type of each FC, and any of the above character IDs 331 is set as the FC type 352. The FC appearance state 353 is data indicating whether or not the FC is currently appearing (placed) on the field. For example, if the FC is appearing on the field, “YES” is set, and if the FC is not appearing, “NO” is set. The FC current position 354 is data indicating the current position of the FC on the field. The FC current state 355 is data indicating which of the “non-battle state”, the “battle state”, and the “chance state” described above the FC is in. The FC status 356 is data indicating the current hit points, etc., of each FC. The FC attacking flag 357 is a flag indicating whether or not the FC is currently performing an attack motion (an attack motion is being reproduced). In addition, although not shown, the FC management data 318 also includes various data required for managing FCs in the game processing.

Referring back to FIG. 28, the operation data 319 is data indicating the contents of various operations performed on the controller. The operation data 319 includes data indicating a pressed state of each button of the controller and an input state of each stick of the controller.

The lock-on target data 320 is data specifying the FC that is a lock-on target.

The capture candidate data 321 is data specifying an FC for which a determination as to whether or not capture is successful is to be performed (hereinafter referred to as capture candidate).

The lock-on flag 322 is a flag indicating whether or not it is in a lock-on state in the above ready state. When the lock-on flag 322 is ON, it indicates that it is in a lock-on state where a predetermined FC is being locked on.

The appearance representation flag 323 is a flag indicating whether or not the above appearance representation is being performed.

In addition, although not shown, various data required for the game processing are also stored in the DRAM 85.

### Details of Processing Executed by Processor 81

Next, the details of the game processing in the exemplary embodiment will be described. Flowcharts described below are merely an example of the processing. Therefore, the order of each process step may be changed as long as the same result is obtained. In addition, the values of variables and thresholds used in determination steps are also merely examples, and other values may be used as necessary.

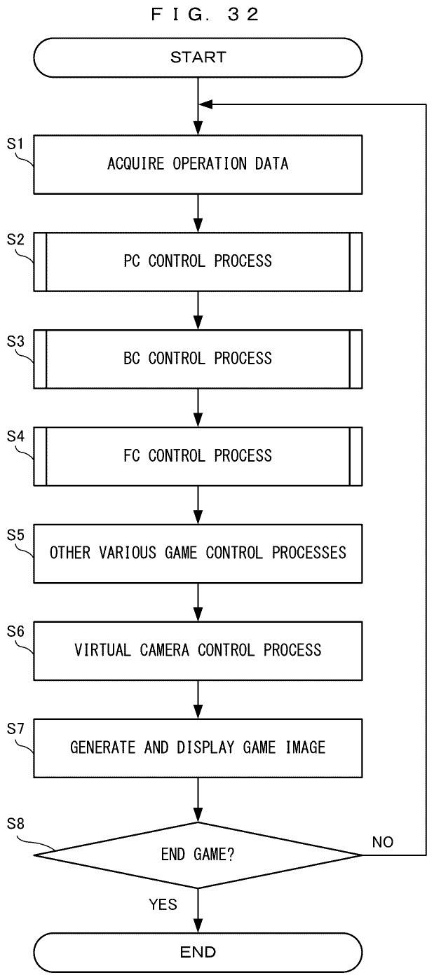

FIG. 32 is a flowchart showing the details of the game processing according to the exemplary embodiment. A process loop of steps S1 to S8 in FIG. 32 is repeated multiple times per second according to a frame rate. In addition, prior to the start of the processing, initialization of various data and a process of placing various FCs and the PC on the field have been completed.

In FIG. 32, first, in step S1, the processor 81 acquires the operation data 319.

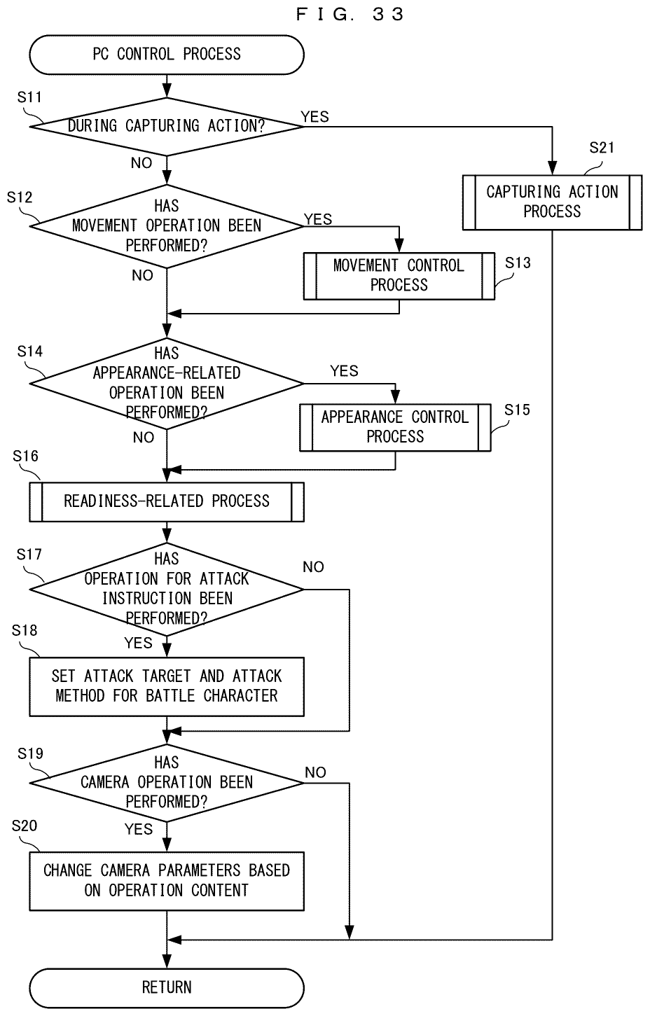

Next, in step S2, the processor 81 executes a PC control process. FIG. 33 is a flowchart showing the details of the PC control process. In FIG. 33, first, in step S11, the processor 81 determines whether or not the PC is in the capturing action state, based on the PC state data 304. If, as a result of the determination, the PC is not in the capturing action state (NO in step S11), in step S12, the processor 81 determines whether or not a movement operation (operation on the left stick 32) has been performed, based on the operation data 319. If, as a result of the determination, the movement operation has been performed (YES in step S12), in step S13, the processor 81 executes a movement control process.

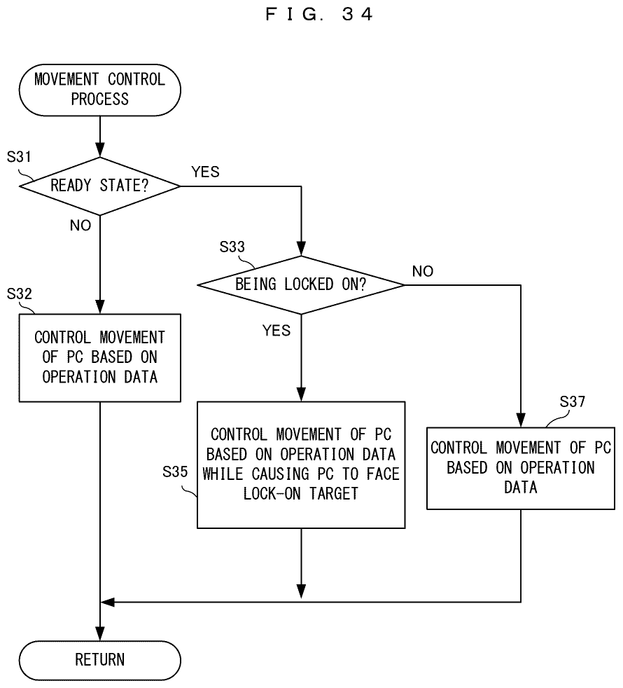

FIG. 34 is a flowchart showing the details of the movement control process. In FIG. 34, first, in step S31, the processor 81 determines whether or not the PC is in the ready state, based on the PC state data 304. If, as a result of the determination, the PC is not in the ready state (NO in step S31), in step S32, the processor 81 controls the movement of the PC, based on the operation content. On the other hand, if the PC is in the ready state (YES in step S31), in step S33, the processor 81 determines whether or not a predetermined FC is currently locked on, based on the lock-on flag 322. If, as a result of the determination, the FC is currently locked on (YES in step S33), in step S35, the processor 81 controls the movement of the PC, based on the operation data 319, while causing the PC to face the lock-on target. Then, the processor 81 ends the movement control process.

On the other hand, if, as a result of the determination in step S33 above, the FC is not locked on (NO in step S33), in step S37, the processor 81 moves the PC, based on the operation data 319. As an example, the processor 81 may control the movement of the PC such that the movement is a strafing movement as described above. Then, the processor 81 ends the movement control process.

Referring back to FIG. 33, if, as a result of the determination in step S12 above, the movement operation has not been performed (NO in step S12), next, in step S14, the processor 81 determines whether or not an appearance-related operation has been performed, based on the operation data 319. Here, the appearance-related operation is assumed to be either the above BC appearance operation or an operation for cancelling an appearing state of the BC (return operation). If any of these operations has been performed (YES in step S14), in step S15, the processor 81 executes an appearance control process.

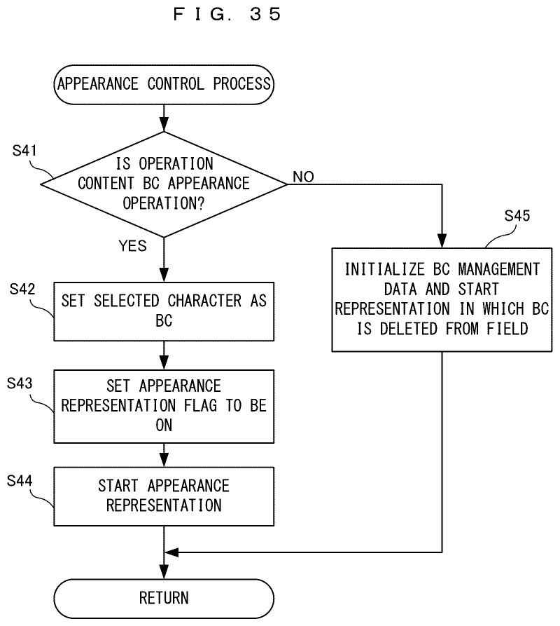

FIG. 35 is a flowchart showing the details of the appearance control process. First, in step S41, the processor 81 determines whether the operation content is the BC appearance operation or the return operation, based on the operation data 319. If, as a result of the determination, the operation content is the BC appearance operation (YES in step S41), in step S42, the processor 81 sets an owned character selected when the BC appearance operation is performed, as the BC. For example, in the owned character section 201, a cursor that can be moved left and right using the right direction button 33 and the left direction button 36 may be provided, and an owned character at which the cursor is located when the BC appearance operation is performed may be selected and set as the BC. Specifically, the processor 81 sets the BC management data 311, based on the data regarding the selected owned character. In addition, along with this, the processor 81 also determines the position at which the BC is caused to appear and the trajectory of the above BC ball.

Next, in step S43, the processor 81 sets the appearance representation flag 323 to be ON. Subsequently, in step S44, the processor 81 starts the appearance representation as shown in FIG. 17 to FIG. 19 above. As this representation, a representation in which the BC ball moves along the determined trajectory of the BC ball and then the BC appears, is displayed. Then, the processor 81 ends the appearance control process.

On the other hand, if, as a result of the determination in step S41 above, the operation content is the return operation (NO in step S41), in step S45, the processor 81 initializes the BC management data 311. Accordingly, the BC is deleted from the field. Furthermore, the processor 81 starts a predetermined representation in which the BC that has appeared is deleted from the field. Then, the processor 81 ends the appearance control process.

Referring back to FIG. 33, if, as a result of the determination in step S14 above, the appearance-related operation has not been performed (NO in step S14), next, in step S16, the processor 81 executes a readiness-related process.

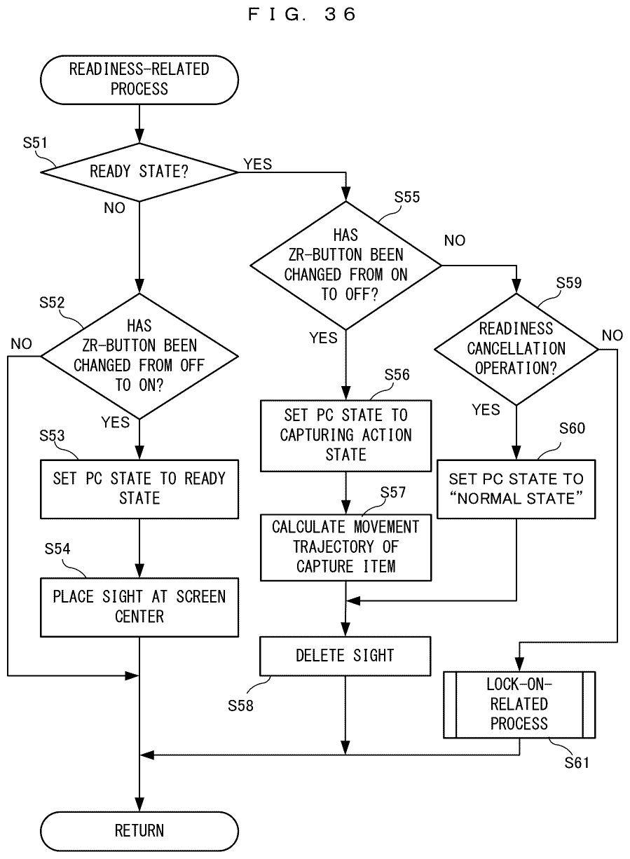

FIG. 36 is a flowchart showing the details of the readiness-related process. First, in step S51, the processor 81 determines whether or not the PC is in the ready state, based on the PC state data 304. If, as a result of the determination, the PC is not in the ready state (NO in step S51), in step S52, the processor 81 determines whether or not the above ready operation has been performed. That is, the processor 81 determines whether or not an operation of changing the ZR-button 61 from an OFF state to an ON state has been performed, based on the operation data 319. If, as a result of the determination, the ready operation has been performed (YES in step S52), in step S53, the processor 81 sets the “ready state” in the PC state data 304. Next, in step S54, the processor 81 places the above sight 203 such that the sight 203 is displayed at the position of the screen center. Then, the processor 81 ends the readiness-related process.

On the other hand, if, as a result of the determination in step S52 above, the ready operation has not been performed (NO in step S52), the processes in steps S53 and S54 above are skipped.

On the other hand, if, as a result of the determination in step S51 above, the PC is in the ready state (YES in step S51), in step S55, the processor 81 determines whether or not an operation of changing the ZR-button 61 from an ON state to an OFF state has been performed, based on the operation data 319. That is, the processor 81 determines whether or not the finger has been separated from the continuously pressed ZR-button 61. If, as a result of the determination, the finger has been separated from the ZR-button 61 (YES in step S55), in step S56, the processor 81 sets the “capturing action state” in the PC state data 304. In addition, the processor 81 causes the PC to start a motion related to a capturing action, that is, causes the PC to start a motion of throwing the capture item 202 as shown in FIG. 12 above. Next, in step S57, the processor 81 calculates the trajectory of the capture item 202, based on the position of the sight 203 at this time, and sets the calculated trajectory in the movement trajectory data 306.

Next, in step S58, the processor 81 deletes the sight 203 from the screen. Then, the processor 81 ends the readiness-related process.

On the other hand, if, as a result of the determination in step S55 above, the finger has not yet been separated from the ZR-button 61 (NO in step S55), in step S59, the processor 81 determines whether or not the above readiness cancellation operation has been performed. If, as a result of the determination, the readiness cancellation operation has been performed (YES in step S59), in step S60, the processor 81 sets the “normal state” in the PC state data 304. Then, the processor 81 advances the processing to step S58 above.

On the other hand, if, as a result of the determination in step S59 above, the readiness cancellation operation has not been performed (NO in step S59), in step S61, the processor 81 executes a lock-on-related process.

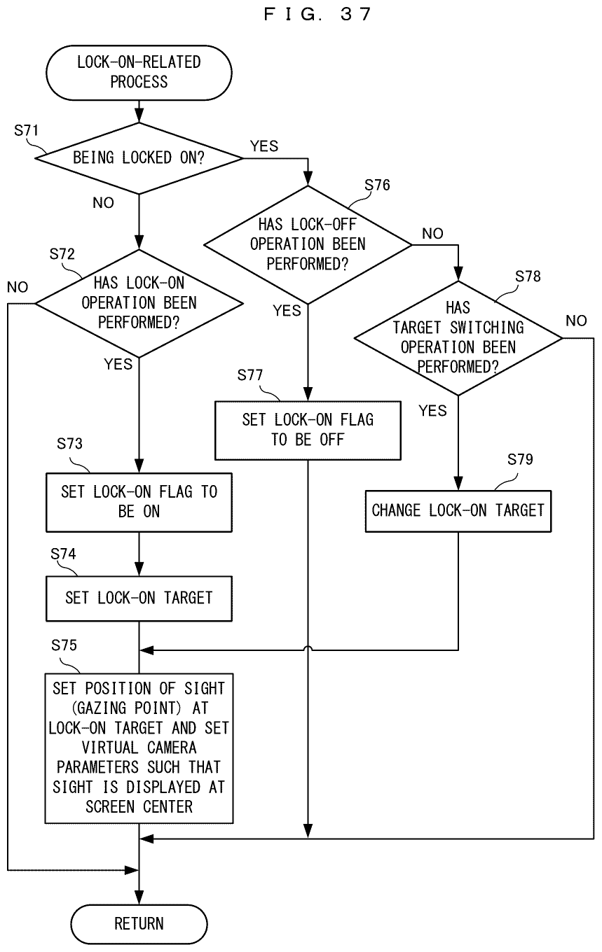

FIG. 37 is a flowchart showing the details of the lock-on-related process. In FIG. 37, first, in step S71, the processor 81 determines whether or not lock-on is currently performed, based on the lock-on flag 322. If, as a result of the determination, lock-on is not currently performed (NO in step S71), in step S72, the processor 81 determines whether or not the above lock-on operation has been performed, based on the operation data 319. If, as a result of the determination, the lock-on operation has been performed (YES in step S72), in step S73, the processor 81 sets the lock-on flag 322 to be ON. Next, in step S74, the processor 81 specifies a lock-on target and sets the lock-on target data 320. For example, the processor 81 sets an FC nearest to the position of the sight 203 at this time, as the lock-on target.

Next, in step S75, the processor 81 sets the position of the sight 203 to a position at which the sight 203 is to be displayed so as to overlap the FC that is the lock-on target. Then, the processor 81 sets the parameters of the virtual camera such that the sight 203 and the locked-on FC are always displayed at the screen center. Then, the processor 81 ends the lock-on-related process.

On the other hand, if the lock-on operation has not been performed (NO in step S72), the processes in steps S73 to S75 above are skipped.

On the other hand, if, as a result of the determination in step S71 above, lock-on is currently performed (YES in step S71), in step S76, the processor 81 determines whether or not the above lock-off operation has been performed. If, as a result of the determination, the lock-off operation has been performed (YES in step S76), in step S77, the processor 81 sets the lock-on flag 322 to be OFF. Then, the processor 81 ends the lock-on-related process.

On the other hand, if, as a result of the determination in step S76 above, the lock-off operation has not been performed either (NO in step S76), in step S78, the processor 81 determines whether or not an operation for switching the lock-on target (in this example, an operation on the right stick 52) has been performed. If, as a result of the determination, the operation for switching the lock-on target has been performed (YES in step S78), in step S79, the processor 81 changes the lock-on target, based on the operation content, and resets the content of the lock-on target data 320. Then, the processor 81 advances the processing to step S75 above.

On the other hand, if the operation for switching the lock-on target has not been performed, the process in step S79 above is skipped and the lock-on-related process ends.

Referring back to FIG. 36, if the lock-on-related process ends, the readiness-related process ends.

Referring back to FIG. 33, next, in step S17, the processor 81 determines whether or not an operation for an attack instruction to the BC has been performed. That is, it is determined whether or not any of the ABXY buttons has been pressed in a state where the BC has appeared. If, as a result of the determination, the operation for an attack instruction has been performed (YES in step S17), in step S18, the processor 81 sets the specified attack method data 317, based on the operation content. In addition, in this case, the player may be able to specify an FC to be attacked. In this case, a process of setting the specified FC in the attack target data 316 is also performed.

On the other hand, if the operation for an attack instruction has not been performed (NO in step S17), the process in step S18 above is skipped.

Next, in step S19, the processor 81 determines whether or not an operation for changing the orientation of the virtual camera has been performed, based on the operation data 319. That is, the processor 81 determines whether or not an operation on the right stick 52 has been performed when the PC is in the normal state. If this operation has been performed (YES in step S19), in step S20, the processor 81 changes the parameters of the virtual camera (orientation of the virtual camera) based on the operation content. On the other hand, if the operation for changing the orientation of the virtual camera has not been performed (NO in step S19), the process in step S20 above is skipped. Then, the processor 81 ends the PC control process.

Next, processing performed if, as a result of the determination in step S11 above, the PC is in the capturing action state (YES in step S11) will be described. In this case, in step S21, the processor 81 executes a capturing action process.

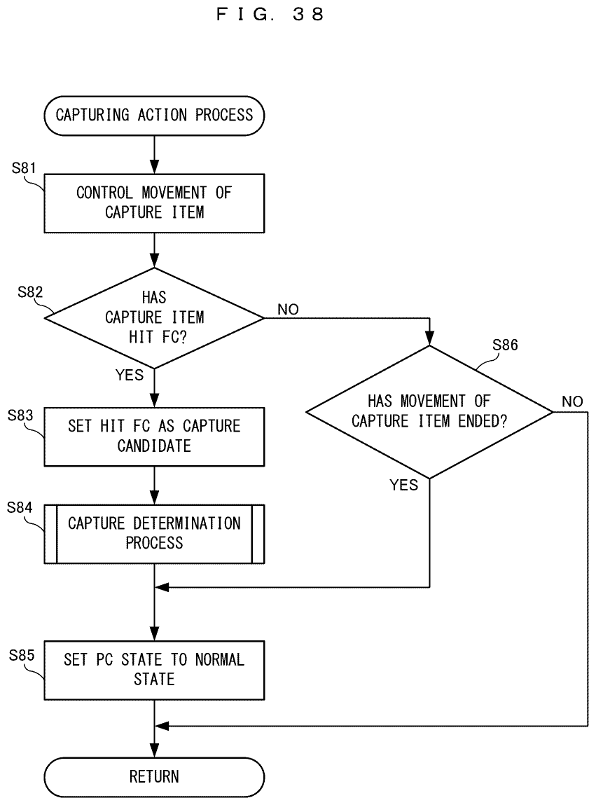

FIG. 38 is a flowchart showing the details of the capturing action process. In FIG. 38, first, in step S81, the processor 81 moves the capture item 202 based on the above movement trajectory data 306. Along with this, the current position data 307 is also updated. In addition, at this time, if the motion related to the capturing action of the PC has not ended, this motion is also continued.

Next, in step S82, the processor 81 determines whether or not the capture item 202 has hit the FC. As for this hit determination, it may be determined that the capture item 202 has hit the FC, when the capture item 202 and the FC collide with each other. In addition, in another exemplary embodiment, even if the capture item 202 and the FC have not collided exactly, it may be determined that the capture item 202 has hit the FC, when a positional relationship in which the capture item 202 and the FC are close to each other is established (even if the capture item 202 and the FC are slightly offset from each other).

If, as a result of the above determination, the capture item 202 has hit the FC (YES in step S82), in step S83, the processor 81 sets the hit FC as a capture candidate in the capture candidate data 321.

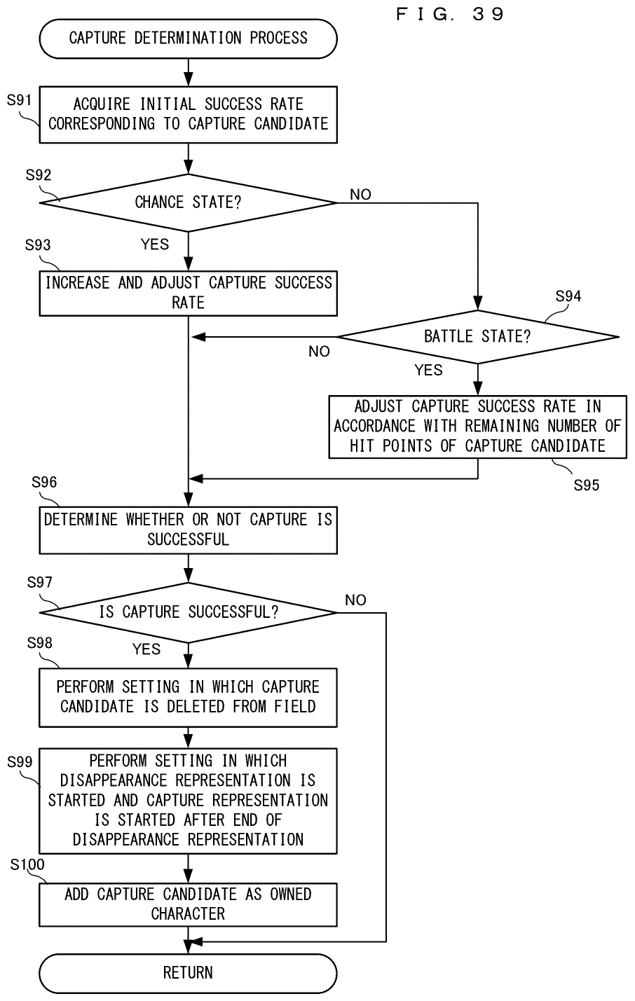

Next, in step S84, the processor 81 executes a capture determination process with the above capture candidate as a target. FIG. 39 is a flowchart showing the details of the capture determination process. In FIG. 39, first, in step S91, the processor 81 refers to the character master data 309 and acquires the initial success rate 334 corresponding to the above capture candidate.

Next, in step S92, the processor 81 determines whether or not the capture candidate is currently in the “chance state”, based on the FC management data 318. If, as a result of the determination, the capture candidate is in the “chance state” (YES in step S92), in step S93, the processor 81 adjusts the capture success rate such that the capture success rate is made higher than the above initial success rate 334. Then, the processor 81 advances the processing to step S96 described later.

If the capture candidate is not in the “chance state” (NO in step S92), next, in step S94, the processor 81 determines whether or not the capture target is in the “battle state”. If, as a result of the determination, the capture target is in the “battle state” (YES in step S94), in step S95, the processor 81 adjusts the capture success rate in accordance with the remaining number of hit points of the capture target. In this example, the capture success rate is adjusted such that the fewer the hit points are, the higher the capture success rate is than the initial success rate 334. Then, the processor 81 advances the processing to step S96 described later.

On the other hand, if the capture target is not in the “battle state” (NO in step S94), the process in step S95 above is skipped. In this case, the current situation is a situation in which a capture determination is performed in the “non-battle state”, and the determination is performed with the above initial success rate 334 kept unchanged.

Next, in step S96, the processor 81 performs a determination as to whether or not capture is successful, using the capture success rate adjusted in steps S92 to S95 above or the capture success rate that is the above initial success rate 334 kept unchanged.

Next, in step S97, the processor 81 determines whether or not the capture is successful as a result of the determination as to whether or not the capture is successful. If, as a result of the determination, the capture is successful (YES in step S97), in step S98, the processor 81 deletes the capture target from the field. Specifically, the processor 81 sets “NO” to the FC appearance state 353 of the capture candidate in the FC management data 318.

Next, in step $99, the processor 81 performs setting for displaying the disappearance representation and the capture representation as shown in FIG. 14 to FIG. 16 above.

Next, in step S100, the processor 81 adds the above capture candidate to the owned character data 310. Then, the processor 81 ends the capture determination process.

On the other hand, if, as a result of the determination in step S97 above, the capture fails (NO in step S97), the processes in steps S98 to S100 above are skipped and the capture determination process ends.

Referring back to FIG. 38, next, in step S85, the processor 81 sets the “normal state” in the PC state data 304. Then, the processor 81 ends the capturing action process.

On the other hand, if, as a result of the determination in step S82 above, the capture item has not hit the FC (NO in step S82), in step S86, the processor 81 determines whether or not the movement of the capture item 202 has ended. That is, it is determined whether or not the capture item 202 has landed on the ground without hitting the FC. If, as a result of the determination, the movement has ended (YES in step S86), the processor 81 advances the processing to step S85 above. As a result, a result that the capturing action has ended without the capture item hitting the FC is fixed. On the other hand, if the movement has not ended yet (NO in step S86), the capturing action process ends.

Referring back to FIG. 33, if the capturing action process ends, the processor 81 ends the PC control process.

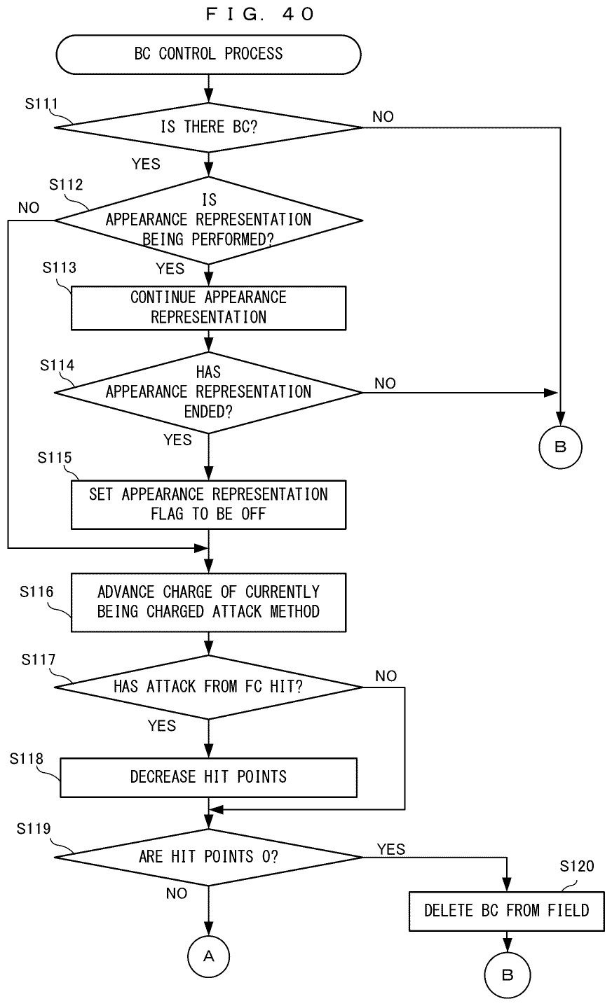

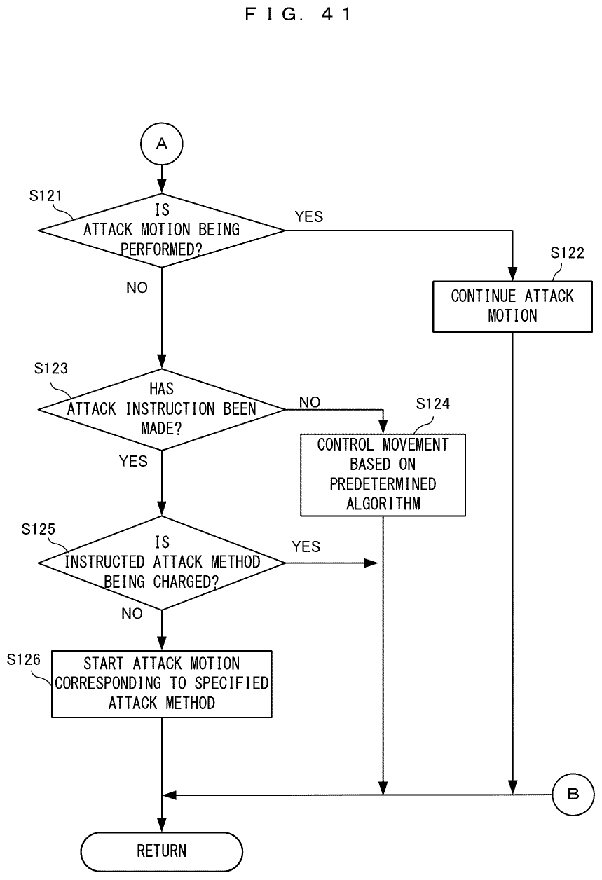

Referring back to FIG. 32, next, in step S3, the processor 81 executes a BC control process. FIG. 40 and FIG. 41 are flowcharts showing the details of the BC control process. First, in step S111, the processor 81 determines whether or not there is a BC that has appeared, based on the BC management data 311. If, as a result of the determination, there is no BC (NO in step S111), the processor 81 ends the BC control process.

On the other hand, if there is a BC that has appeared (YES in step S111), in step S112, the processor 81 determines whether or not the appearance representation is currently performed, based on the appearance representation flag 323. If the appearance representation is currently performed (YES in step S112), in step S113, the processor 81 continues the appearance representation. Next, in step S114, the processor 81 determines whether or not the appearance representation has ended. If the appearance representation has ended (YES in step S114), in step S115, the processor 81 sets the appearance representation flag 323 to be OFF. Then, the processor 81 advances the processing to step S116.

On the other hand, if, as a result of the determination in step S114, the appearance representation has not ended (NO in step S114), the processor 81 ends the BC control process.

On the other hand, if, as a result of the determination in step S112 above, the appearance representation is not currently performed (NO in step S112), in step S116, if there is an attack method currently being charged among the attack methods that the BC has, the processor 81 advances the charge of this attack method.

Next, in step S117, the processor 81 determines whether or not an attack from any of the FCs has hit the BC. If, as a result of the determination, the attack has hit the BC (YES in step S117), the processor 81 calculates a damage value, based on the attack method by which the BC has been hit. Then, the processor 81 updates the BC status 315 such that the hit points are decreased by the damage value.

On the other hand, if no attack from any FC has hit the BC (NO in step S117), the process in step S118 above is skipped.

Next, in step S119, the processor 81 determines whether or not the hit points of the BC are 0, based on the BC status 315. If, as a result of the determination, the hit points are 0 (YES in step S119), in step S120, the processor 81 executes a process for deleting the BC that has appeared, from the field. Specifically, the processor 81 starts a disappearance representation in which the BC disappears from the field, and initializes the BC management data 311. Then, the processor 81 ends the BC control process.

On the other hand, if the hit points are not 0 (NO in step S119), next, in step S121 in FIG. 41, the processor 81 determines whether or not the BC is currently performing an attack motion. That is, it is determined whether an attack motion corresponding to a predetermined attack method is being reproduced. If, as a result of the determination, the BC is currently performing the attack motion (YES in step S121), in step S122, the processor 81 causes the BC to continue the attack motion. Then, the processor 81 ends the BC control process.

On the other hand, if the BC is not currently performing the attack motion (NO in step S121), next, in step S123, the processor 81 determines whether or not an attack instruction has been made, based on the operation data 319. If, as a result of the determination, an attack instruction has not been made (NO in step S123), in step S124, the processor 81 controls the action of the BC, based on the above action algorithm 335. For example, a process of controlling the movement of the BC or setting the nearest FC in the attack target data 316 is performed. Then, the BC control process ends.

On the other hand, if an attack instruction has been made (YES in step S123), in step S125, the processor 81 determines whether or not the specified attack method is currently being charged. If the specified attack method is currently being charged (YES in step $125), the processor 81 ends the BC control process. That is, even if the button corresponding to the currently being charged attack method is pressed, the BC does not do anything. On the other hand, if the specified attack method is currently not being charged (NO in step S125), in step S126, the processor 81 sets information indicating the specified attack method, in the specified attack method data 317, and causes the BC to start an attack motion corresponding to the specified attack method. At this time, the processor 81 empties the charge meter for this attack method and starts charging the attack method. Then, the processor 81 ends the BC control process.

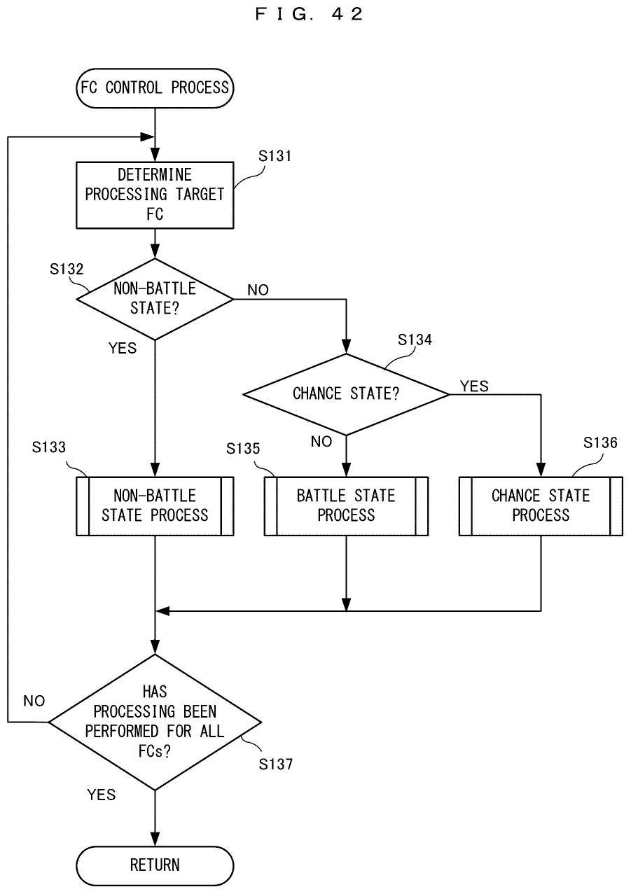

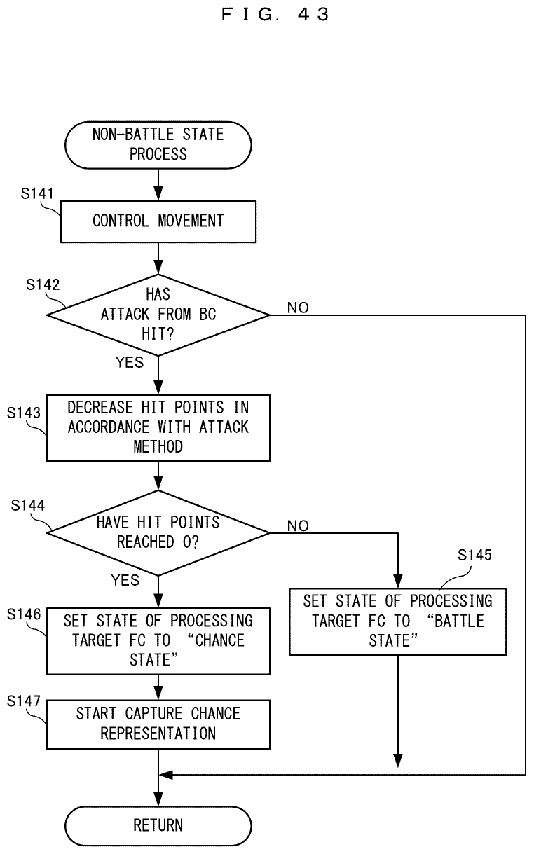

Referring back to FIG. 32, next to the BC control process, the processor 81 executes an FC control process in step S4. FIG. 42 is a flowchart showing the details of the FC control process. First, in step S131, the processor 81 selects one FC to be the target of processing described below, from among the FCs for which the FC appearance state 353 in the FC management data 318 is “YES”. Hereinafter, this FC is referred to as processing target FC.

Next, in step S132, the processor 81 determines whether or not the processing target FC is in the non-battle state, based on the FC current state 355. If, as a result of the determination, the processing target FC is in the non-battle state (YES in step S132), in step S133, the processor 81 executes a non-battle state process. Then, the processor 81 advances the processing to step S137 described later.

FIG. 43 is a flowchart showing the details of the non-battle state process. First, in step S141, the processor 81 controls the movement of the processing target FC, based on the above action algorithm 335.

Next, in step S142, the processor 81 determines whether or not an attack from the BC has hit the processing target FC. If, as a result of the determination, the attack has not hit the processing target FC (NO in step S142), the processor 81 ends the non-battle state process. On the other hand, if the attack has hit the processing target FC (YES in step $142), in step S143, the processor 81 calculates a damage value corresponding to the attack method specified by the specified attack method data 317. Then, the processor 81 updates the FC status 356 such that the hit points are decreased by the damage value.

Next, in step S144, the processor 81 determines whether or not the hit points of the processing target FC have reached 0. If, as a result of the determination, the hit points have reached 0 (YES in step S144), in step S146, the processor 81 sets the “chance state” to the FC current state 355 of the processing target FC. Next, in step S147, the processor 81 starts the capture chance representation as shown in FIG. 23 above. Then, the processor 81 ends the non-battle state process.

On the other hand, if the hit points have not reached 0 (NO in step S144), in step S145, the processor 81 sets the “battle state” to the FC current state 355 of the processing target FC. Then, the processor 81 ends the non-battle state process.

Referring back to FIG. 42, if, as a result of the determination in step S132 above, the processing target FC is not in the “non-battle state” (NO in step S132), next, in step S134, the processor 81 determines whether or not the processing target FC is in the “chance state”. If, as a result of the determination, the processing target FC is not in the “chance state” (NO in step S134), in step S135, the processor 81 executes a battle state process. On the other hand, if the processing target FC is in the “chance state” (YES in step S134), in step S136, the processor 81 executes a chance state process.

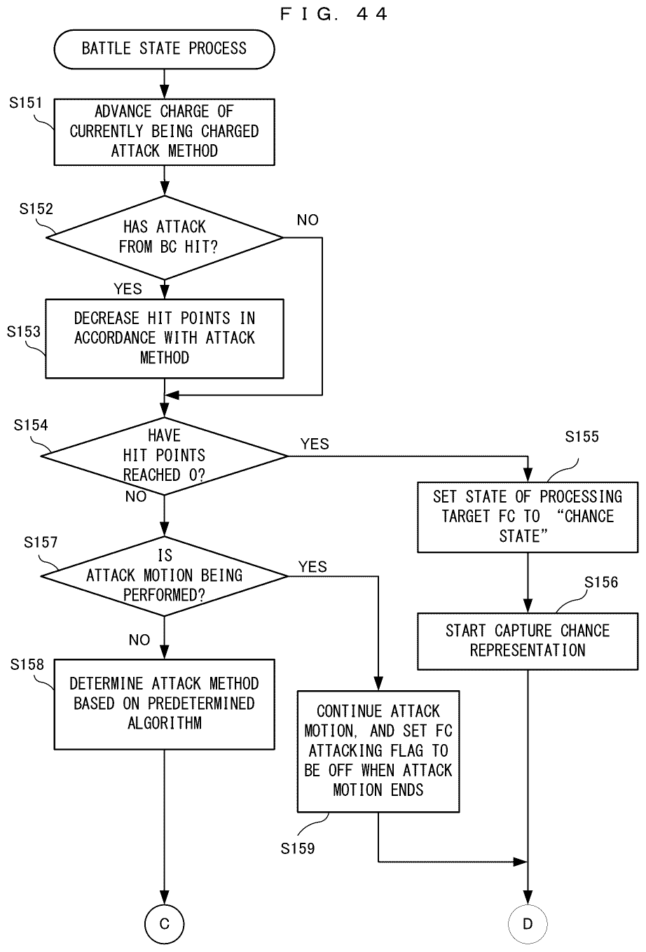

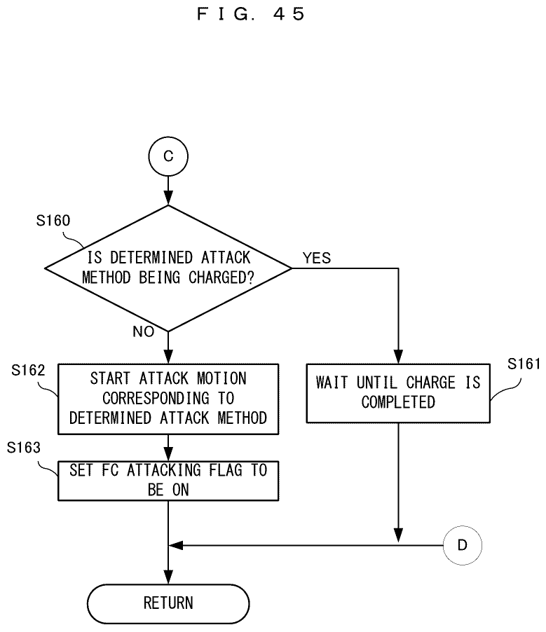

FIG. 44 and FIG. 45 are flowcharts showing the details of the battle state process. In FIG. 44, first, in step S151, if there is an attack method currently being charged among attack methods that the FC has, the processor 81 advances the charge of this attack method.

Next, in step S152, the processor 81 determines whether or not an attack from the BC has hit the processing target FC. If, as a result of the determination, the attack has hit the processing target FC (YES in step S152), in step S153, the processor 81 calculates a damage value corresponding to the attack method specified by the specified attack method data 317. Then, the processor 81 updates the FC status 356 such that the hit points are decreased by the damage value. On the other hand, if the attack has not hit the processing target FC (NO in step S152), the processor 81 skips the process in step S153 above.

Next, in step S154, the processor 81 determines whether or not the hit points of the processing target FC have reached 0. If, as a result of the determination, the hit points have reached 0 (YES in step S154), in step S155, the processor 81 sets the “chance state” to the FC current state 355 of the processing target FC. Next, in step S156, the processor 81 starts the capture chance representation as shown in FIG. 23 above. Then, the processor 81 ends the battle state process.

On the other hand, if, as a result of the determination in step S154 above, the hit points are not 0 (NO in step S154), in step S157, the processor 81 determines whether or not the processing target FC is currently performing an attack motion, based on the FC attacking flag 357. If, as a result of the determination, the processing target FC is currently performing an attack motion (YES in step S157), in step S159, the processor 81 causes the processing target FC to continue the current attack motion. In addition, if the attack motion ends as a result, the processor 81 sets the FC attacking flag 357 to be OFF. Then, the processor 81 ends the battle state process.

On the other hand, if the processing target FC is not currently performing an attack motion (NO in step S157), in step S158, the processor 81 determines an attack method, based on the above action algorithm 335.

Next, in step S160 in FIG. 45, the processor 81 determines whether or not the determined attack method is currently being charged. If the determined attack method is currently being charged (YES in step S160), in step S161, the processor 81 causes the processing target FC to wait until the charging is completed. On the other hand, if the determined attack method is currently not being charged (NO in step S160), in step S162, the processor 81 causes the processing target FC to start an attack motion corresponding to the determined attack method. In addition, at this time, the processor 81 empties the charge meter for this attack method and starts charging the attack method.

Next, in step S163, the processor 81 sets the FC attacking flag 357 of the processing target FC to be ON. Then, the processor 81 ends the battle state process.

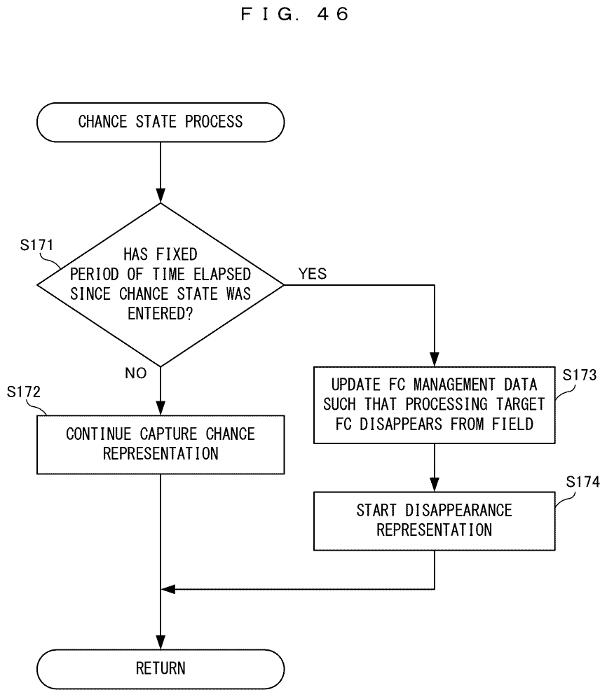

Next, the chance state process will be described. FIG. 46 is a flowchart showing the details of the chance state process. In FIG. 46, first, in step S171, the processor 81 determines whether or not a fixed period of time has elapsed since the chance state was entered. If, as a result of the determination, the fixed period of time has not elapsed (NO in step S171), in step S172, the processor 81 continues to display the above capture chance representation. Then, the processor 81 ends the chance state process.

On the other hand, if the fixed period of time has elapsed since the chance state was entered (YES in step S171), in step S173, the processor 81 sets “NO” to the FC appearance state 353 of the processing target FC in the FC management data 318. This means that setting in which the processing target FC disappears from the field has been performed.

Next, in step S174, the processor 81 starts a disappearance representation for the processing target FC. Then, the processor 81 ends the chance state process.

Referring back to FIG. 42, if any of the processes in steps S133, S135, and S136 above is completed, next, in step S137, the processor 81 determines whether or not the above processing has been performed for all the FCs for which the FC appearance state 353 in the FC management data 318 is “YES”. If there is an FC for which the processing has not been performed yet (NO in step S137), the processor 81 returns to step S131 above and repeats the processing. If the above processing has been performed for all the FCs (YES in step S137), the processor 81 ends the FC control process.

Referring back to FIG. 32, next, in step S5, the processor 81 executes various game control processes other than the above. For example, the processor 81 performs various types of collision determination other than the above and executes processes based on the results of the collision determination. In addition, for example, a process of adding damage over time such as damage by poison to the BC or FC, a process of controlling the operation of various gimmicks installed on the field, etc., are also executed as appropriate.

Next, in step S6, the processor 81 executes a virtual camera control process. In this process, the virtual camera is controlled based on the virtual camera parameters set by the above processing.

Next, in step S7, the processor 81 generates and outputs a game image reflecting the above processing content.

Next, in step S8, the processor 81 determines whether or not an instruction to end the game has been made. If the instruction has not been made (NO in step S8), the processor 81 returns to step S1 above and repeats the processing. If the instruction has been made (YES in step S8), the processor 81 ends the game processing.

As described above, in the exemplary embodiment, even if, as a result of battling with the FC, the FC is defeated, an opportunity to capture the FC is provided. In addition, an opportunity to be able to capture the FC even when the FC is in the non-battle state is provided, and furthermore, an opportunity to be able to capture the FC even in a state where the FC and the BC are battling with each other is provided. Accordingly, it is possible to capture the FC in a variety of situations, so that it is possible to improve the entertainment characteristics of the game.

### Modifications

In the above embodiment, the example in which it is possible to capture the FC even when the FC is in the “battle state”, has been described. In another exemplary embodiment, it may be impossible to capture the FC when the FC is in the “battle state”. For example, even if a capturing action is performed, a motion in which the capture item is repelled by the FC may be performed.

In the above embodiment, the example in which the “chance state” ends when the fixed period of time has elapsed since the FC shifted to the “chance state”, has been described. Also, the example in which an attempt to capture the FC can be made as many times as desired while the FC is in the “chance state”, has been described. In this regard, in another exemplary embodiment, a limit may be set on the number of attempts to capture the FC while the FC is in the “chance state”. For example, in the case where the number of attempts is set to three, if the FC cannot be captured as a result of attempting to capture the FC three times while the FC is in the “chance state”, even when the fixed period of time has not elapsed since the FC shifted to the “chance state”, the “chance state” may be ended at that time.

In the above embodiment, when the hit points of the FC reach 0, the FC is considered to have been defeated and shifts to the “chance state”. In this regard, the determination as to whether the FC has been defeated is not limited to whether or not the hit points have reached 0, and it may be determined that the FC has been defeated, when the hit points become equal to or less than a predetermined value, for example, 10%.

In the above embodiment, the example in which the FC shifts to the “battle state” if the capture fails as a result of performing a capturing action when the FC is in the “non-battle state”, has been described. In this regard, in another exemplary embodiment, if the capture fails, the FC may be caused to escape. For example, whether to shift to the “battle state” or to escape may be set in advance according to the type of FC, or whether to shift to the “battle state” or to escape may be determined by random selection when the capture fails.

In the above embodiment, the case of causing only one BC to appear has been shown as an example, but in another exemplary embodiment, it may be possible to cause a plurality of BCs to appear.

In the above embodiment, the case where the above game processing is executed by a single main body apparatus 2 has been described. The main body apparatus 2 may include a plurality of storages and a plurality of processors. The above game processing may be shared and executed by these storages and processors. The above processing may be executed in a distributed system including a server and a plurality of information processing apparatuses.

While the present disclosure has been described in detail, the foregoing description is in all aspects illustrative and not restrictive. It is to be understood that numerous other modifications and variations can be devised without departing from the scope of the present disclosure.

1. A non-transitory computer-readable storage medium having stored therein a game program causing a computer of an information processing apparatus to:
control a player character in a virtual space, based on an operation input;
cause the player character to perform a capturing motion of releasing a capture item for capturing one or more field characters placed on a field, in a specified direction in response to a first instruction based on an operation input;
in a scene where it is possible to capture a first field character among the field characters, when the capture item is released toward the first field character in accordance with the capturing motion, perform a capture success determination as to whether or not a capture by the capturing motion is successful, and if the capture is successful, bring the first field character into a state of being owned by a player;
cause a first battle character among battle characters owned by the player and capable of battling on the field to perform an attack motion against the first field character in response to a second instruction based on an operation input; and
perform a defeat determination as to whether or not the first field character has been defeated, based on the attack motion of the first battle character, and if the first field character has been defeated,
make the first field character capturable in a first period after the defeat, and
make the first field character un-capturable after the first period has elapsed.

2. The non-transitory computer-readable storage medium according to claim 1, wherein the game program further causes the computer to:
when the first field character is in a battle state out of the battle state and a non-battle state, cause the first field character to perform an attack motion against the player character or the first battle character; and
when the first field character is in the non-battle state, if the first battle character has performed an attack motion against the first field character, bring the first field character into the battle state.

3. The non-transitory computer-readable storage medium according to claim 2, wherein the game program further causes the computer to make the first field character capturable when the first field character is in the non-battle state.

4. The non-transitory computer-readable storage medium according to claim 3, wherein the game program further causes the computer to, when the first field character is in the non-battle state, bring the first field character into the battle state if a result of the capture success determination in accordance with the capturing motion against the first field character is a failure.

5. The non-transitory computer-readable storage medium according to claim 2, wherein the game program further causes the computer to make the first field character capturable when the first field character is in the battle state.

6. The non-transitory computer-readable storage medium according to claim 5, wherein the game program further causes the computer to:
decrease hit points set for the first field character, based on an attack motion of the first battle character against the first field character;
make it easier for a result of the capture success determination in accordance with the capturing motion to be a success as the hit points decrease; and
if the hit points become equal to or lower than a predetermined value, perform the defeat determination that the first field character has been defeated.

7. The non-transitory computer-readable storage medium according to claim 6, wherein the game program further causes the computer to bring the first field character into a state of not performing the attack motion against the first battle character and not moving, during the first period.

8. The non-transitory computer-readable storage medium according to claim 2, wherein the game program further causes the computer to
when the first battle character has not appeared on the field,
in response to a third instruction based on an operation input, cause the player character to perform a battle character appearance motion of releasing the first battle character in a specified direction to cause the first battle character to appear on the field.

9. The non-transitory computer-readable storage medium according to claim 8, wherein the game program further causes the computer to bring the first field character into the battle state when the first battle character is released toward the first field character based on the battle character appearance motion.

10. The non-transitory computer-readable storage medium according to claim 8, wherein the game program further causes the computer to:
control the first battle character that has appeared on the field based on the battle character appearance motion, on the field; and
bring the first field character into the battle state if a positional relationship between the first field character and the first battle character satisfies a predetermined condition.

11. The non-transitory computer-readable storage medium according to claim 1, wherein the game program further causes the computer to make it easier for a result of the capture success determination to be a success in the first period than in a period other than the first period in which the first field character is capturable.

12. The non-transitory computer-readable storage medium according to claim 1, wherein the game program further causes the computer to, after the first period has elapsed, make the first field character un-capturable and delete the first field character from the field.

13. The non-transitory computer-readable storage medium according to claim 1, wherein the game program further causes the computer to, if a result of the capture success determination is a success, bring the field character into a state of being owned as the battle character by the player.

14. The non-transitory computer-readable storage medium according to claim 1, wherein the game program further causes the computer to:
when the first battle character is caused to perform the attack motion, bring the first battle character into an attack standby state where the attack motion cannot be further performed;
cancel the attack standby state to bring the first battle character into an attack-possible state, in accordance with passage of time; and
cause the first battle character to perform the attack motion in response to a predetermined operation input being performed in the attack-possible state as the second instruction.

15. The non-transitory computer-readable storage medium according to claim 1, wherein the game program further causes the computer to end the first period as a result of passage of time.

16. The non-transitory computer-readable storage medium according to claim 15, wherein the game program further causes the computer to end the first period if the capturing motion is performed a predetermined number of times during the first period.

17. A game system comprising a computer, the computer being configured to:
control a player character in a virtual space, based on an operation input;
cause the player character to perform a capturing motion of releasing a capture item for capturing one or more field characters placed on a field, in a specified direction in response to a first instruction based on an operation input;
in a scene where it is possible to capture a first field character among the field characters, when the capture item is released toward the first field character in accordance with the capturing motion, perform a capture success determination as to whether or not a capture by the capturing motion is successful, and if the capture is successful, bring the first field character into a state of being owned by a player;
cause a first battle character among battle characters owned by the player and capable of battling on the field to perform an attack motion against the first field character in response to a second instruction based on an operation input; and
perform a defeat determination as to whether or not the first field character has been defeated, based on the attack motion of the first battle character, and if the first field character has been defeated,
make the first field character capturable in a first period after the defeat, and
make the first field character un-capturable after the first period has elapsed.

18. The game system according to claim 17, wherein the computer is further configured to:
when the first field character is in a battle state out of the battle state and a non-battle state, cause the first field character to perform an attack motion against the player character or the first battle character; and
when the first field character is in the non-battle state, if the first battle character has performed an attack motion against the first field character, bring the first field character into the battle state.

19. The game system according to claim 18, wherein the computer is further configured to make the first field character capturable when the first field character is in the non-battle state.

20. The game system according to claim 19, wherein the computer is further configured to, when the first field character is in the non-battle state, bring the first field character into the battle state if a result of the capture success determination in accordance with the capturing motion against the first field character is a failure.

21. The game system according to claim 18, wherein the computer is further configured to make the first field character capturable when the first field character is in the battle state.

22. The game system according to claim 21, wherein the computer is further configured to:
decrease hit points set for the first field character, based on an attack motion of the first battle character against the first field character;
make it easier for a result of the capture success determination in accordance with the capturing motion to be a success as the hit points decrease; and
if the hit points become equal to or lower than a predetermined value, perform the defeat determination that the first field character has been defeated.

23. The game system according to claim 22, wherein the computer is further configured to bring the first field character into a state of not performing the attack motion against the first battle character and not moving, during the first period.

24. The game system according to claim 18, wherein the computer is further configured to
when the first battle character has not appeared on the field,
in response to a third instruction based on an operation input, cause the player character to perform a battle character appearance motion of releasing the first battle character in a specified direction to cause the first battle character to appear on the field.

25. The game system according to claim 24, wherein the computer is further configured to bring the first field character into the battle state when the first battle character is released toward the first field character based on the battle character appearance motion.

26. The game system according to claim 24, wherein the computer is further configured to:
control the first battle character that has appeared on the field based on the battle character appearance motion, on the field; and
bring the first field character into the battle state if a positional relationship between the first field character and the first battle character satisfies a predetermined condition.

27. A game processing method executed by a computer of an information processing apparatus, the game processing method causing the computer to:
control a player character in a virtual space, based on an operation input;
cause the player character to perform a capturing motion of releasing a capture item for capturing one or more field characters placed on a field, in a specified direction in response to a first instruction based on an operation input;
in a scene where it is possible to capture a first field character among the field characters, when the capture item is released toward the first field character in accordance with the capturing motion, perform a capture success determination as to whether or not a capture by the capturing motion is successful, and if the capture is successful, bring the first field character into a state of being owned by a player;
cause a first battle character among battle characters owned by the player and capable of battling on the field to perform an attack motion against the first field character in response to a second instruction based on an operation input; and
perform a defeat determination as to whether or not the first field character has been defeated, based on the attack motion of the first battle character, and if the first field character has been defeated,
make the first field character capturable in a first period after the defeat, and
make the first field character un-capturable after the first period has elapsed.

28. The game processing method according to claim 27, further causing the computer to:
when the first field character is in a battle state out of the battle state and a non-battle state, cause the first field character to perform an attack motion against the player character or the first battle character; and
when the first field character is in the non-battle state, if the first battle character has performed an attack motion against the first field character, bring the first field character into the battle state.

29. The game processing method according to claim 28, further causing the computer to make the first field character capturable when the first field character is in the non-battle state.

30. The game processing method according to claim 29, further causing the computer to, when the first field character is in the non-battle state, bring the first field character into the battle state if a result of the capture success determination in accordance with the capturing motion against the first field character is a failure.

31. The game processing method according to claim 28, further causing the computer to make the first field character capturable when the first field character is in the battle state.

32. The game processing method according to claim 31, further causing the computer to:
decrease hit points set for the first field character, based on an attack motion of the first battle character against the first field character;
make it easier for a result of the capture success determination in accordance with the capturing motion to be a success as the hit points decrease; and
if the hit points become equal to or lower than a predetermined value, perform the defeat determination that the first field character has been defeated.

33. The game processing method according to claim 32, further causing the computer to bring the first field character into a state of not performing the attack motion against the first battle character and not moving, during the first period.

34. The game processing method according to claim 28, further causing the computer to
when the first battle character has not appeared on the field,
in response to a third instruction based on an operation input, cause the player character to perform a battle character appearance motion of releasing the first battle character in a specified direction to cause the first battle character to appear on the field.

35. The game processing method according to claim 34, further causing the computer to bring the first field character into the battle state when the first battle character is released toward the first field character based on the battle character appearance motion.

36. The game processing method according to claim 34, further causing the computer to:
control the first battle character that has appeared on the field based on the battle character appearance motion, on the field; and
bring the first field character into the battle state if a positional relationship between the first field character and the first battle character satisfies a predetermined condition.

37. The game processing method according to claim 27, further causing the computer to make it easier for a result of the capture success determination to be a success in the first period than in a period other than the first period in which the first field character is capturable.

38. The game processing method according to claim 27, further causing the computer to, after the first period has elapsed, make the first field character un-capturable and delete the first field character from the field.

39. The game processing method according to claim 27, further causing the computer to, if a result of the capture success determination is a success, bring the field character into a state of being owned as the battle character by the player.

40. The game processing method according to claim 27, further causing the computer to:
when the first battle character is caused to perform the attack motion, bring the first battle character into an attack standby state where the attack motion cannot be further performed;
cancel the attack standby state to bring the first battle character into an attack-possible state, in accordance with passage of time; and
cause the first battle character to perform the attack motion in response to a predetermined operation input being performed in the attack-possible state as the second instruction.

41. The game processing method according to claim 27, further causing the computer to end the first period as a result of passage of time.

42. The game processing method according to claim 41, further causing the computer to end the first period if the capturing motion is performed a predetermined number of times during the first period.
